(19) United States
(12) Patent Application Publication
(10) Pub. No.: US 2017/0123678 A1
(43) Pub. Date: May 4, 2017

(54) Garbage Collection for Reference Sets in Flash Storage Systems

(71) Applicant: HGST Netherlands B.V., Amsterdam (NL)

(72) Inventors: Ashish Singhai, Los Altos, CA (US); Saurabh Manchanda, Delhi (IN); Ashwin Narasimha, Los Altos, CA (US); Vijay Karamcheti, Palo Alto, CA (US)

(21) Appl. No.: 14/932,860

(22) Filed: Nov. 4, 2015

(51) Int. Cl. G06F 3/06

(52) U.S. Cl. CPC G06F 3/0608; G06F 3/064; G06F 3/0652; G06F 3/0679

(57) ABSTRACT

A system comprising a processor and a memory storing instructions that, when executed, cause the system to receive data blocks of an incoming data stream, determine a first reference data set associated with a segment of data store based on the received data blocks, determine a state of the first reference data set, determine whether the first reference data set meets a retirement criteria based on the state, and responsive to meeting the retirement criteria, perform retiring of the first reference data set.

### CROSS-REFERENCE TO RELATED APPLICATIONS

This application is related to U.S. patent application Ser. No. ______, filed ______, titled “Reference Block Aggregating Into a Reference Set for Deduplication in Memory Management”; U.S. patent application Ser. No. ______, filed ______, titled “Pipelined Reference Set Construction and Use in Memory Management”; and U.S. patent application Ser. No. ______, filed ______, titled “Integration of Reference Sets with Segment Flash Management”, each of which is incorporated by reference in its entirety.

### BACKGROUND

The present disclosure relates to managing sets of data blocks in a storage device. In particular, the present disclosure describes similarity-based content matching for storage applications and data deduplication. Still more particularly, the present disclosure relates to applying garbage collection to reference data sets in flash storage systems.

Similarity-based content matching can be applied on documents for identifying similarities between a set of documents, as opposed to an exact match. The concept of content matching has been used previously in search engine implementations and in building dynamic random access memory (DRAM) based caches such as, hash lookup based dedupe, which only identifies exact matches as opposed to similarity-based dedupe which identifies approximate matches. However, using similarity-based dedupe in a storage device requires solving a problem associated with reference data set management and construction.

A substantial overhead in block carry-over and garbage collection operations exits in flash management, which can influence performance of flash storage devices. The architecture of flash storage devices limits the amount of available data blocks for storing information. Therefore, as the concentration of a flash storage device increases, the number and size of data blocks is increased, resulting in even more overhead and lower performance for write and rewrite operations. Further, there is a need for continuously minimizing amount of wasted memory in flash storag. Thus, there is a need for efficiently managing sets of data block in flash storage devices by applying garbage collection to reference data set.

### SUMMARY

The present disclosure relates to systems and methods for hardware efficient data management. According to one innovative aspect of the subject matter in this disclosure, a system having one or more processors and a memory storing instructions that, when executed, cause the system to: receive data blocks of an incoming data stream; determine a first reference data set associated with a segment of data store based on the received data blocks; determine a state of the first reference data set; determine whether the first reference data set meets a retirement criteria based on the state; and responsive to meeting the retirement criteria, perform retiring of the first reference data set.

In general, another innovative aspect of the subject matter described in this disclosure may be implemented in methods that include: receiving data blocks of an incoming data stream; determining a first reference data set associated with a segment of data store based on the received data blocks; determining a state of the first reference data set; determining whether the first reference data set meets a retirement criteria based on the state; and responsive to meeting the retirement criteria, performing retiring of the first reference data set.

Other implementations of one or more of these aspects include corresponding systems, apparatus, and computer programs, configured to perform the actions of the methods, encoded on computer storage devices.

These and other implementations may each optionally include one or more of the following features.

For instance, the operations further include: responsive to the state of the first reference data set being below a predetermined value, regenerating original data blocks of the first reference data set; encoding the original data blocks of the first reference data set and the received data blocks of the incoming data stream with a second reference data set stored in the data store; responsive to the state of the first reference data set being above the predetermined value, encoding the received data blocks using the first reference data set; assigning the segment associated with the first reference data set to a new location in the data store for storage; updating a use count associated with the first reference data set; determining whether the reference data set meets a retirement criteria based on the use count; responsive to meeting the retirement criteria, retiring the first reference data set based on a force factor; and performing retiring of the first reference data set; and performing a statistical analysis on a population of data blocks associated with the first reference data set stored in the data store, wherein the statistical analysis includes identifying other reference data sets that are recalled above a predetermined threshold.

For instance, the features may include that the force factor is client defined.

These implementations are particularly advantageous in a number of respects. For instance, the technology describes herein can be used for applying garbage collection to reference data sets in flash storage systems.

It should be understood that language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a high-level block diagram illustrating an example system for managing reference data blocks in a reference data set in a storage device according to the techniques described herein.

FIG. 2 is a block diagram illustrating an example storage controller unit according to the techniques described herein.

FIG. 3A is a block diagram illustrating an example system for managing reference data blocks in a storage device according to the techniques described herein.

FIG. 3B is a block diagram illustrating an example data reduction unit according to the techniques described herein.

FIG. 4 is a flow chart of an example method for generating a reference data set according to the techniques described herein.

FIG. 5 is a flow chart of an example method for aggregating data blocks into a reference data set according to the techniques described herein.

FIGS. 6A-6C are flow charts of an example method for adaptively aggregating reference blocks into a reference data set based on changing data streams, according to the techniques described herein.

FIG. 7 is a flow chart of an example method for encoding data blocks in a pipelined architecture according to the techniques described herein.

FIGS. 8A and 8B are flow charts of an example method for generating a reference data set in a pipelined architecture according to the techniques described herein.

FIG. 9 is a flow chart of an example method for tracking reference data sets in flash storage management according to the techniques described herein.

FIG. 10 is a flow chart of an example method for updating count variables associated with a reference data set according to the techniques described herein.

FIG. 11 is a flow chart of an example method for assigning encoded data segments to a new location in non-transitory data store according to the techniques described herein.

FIG. 12 is a flow chart of an example method for encoding data segments associated with flash management and garbage collection integration according to the techniques described herein.

FIG. 13 is a flow chart of an example method for retiring a reference data set associated with flash management according to the techniques described herein.

FIG. 14A is a block diagram illustrating a prior art example for compressing a reference data block.

FIG. 14B is a block diagram illustrating a prior art example for deduping a reference data block.

FIG. 15 is an example graphical representation illustrating delta encoding according to the techniques described herein.

FIG. 16 is an example graphical representation illustrating resemblance encoding according to the techniques described herein.

FIG. 17 is an example graphical representation illustrating delta and self-compression of a reference data block according to the techniques described herein.

FIGS. 18A and 18B are exemplary graphical representations illustrating tracking and retirement of reference block sets using garbage collection in flash management according to the techniques described herein.

### DETAILED DESCRIPTION

Systems and methods for providing an efficient data management architecture are described below. In particular, in the present disclosure, systems and methods for managing sets of reference data blocks in storage devices and specifically in flash-storage devices are described below. While the systems, methods of the present disclosure are described in the context of particular system architecture that uses flash-storage, it should be understood that the systems and methods can be applied to other architectures and organizations of hardware.

### Overview

The present disclosure describes similarity-based content matching for storage applications and data deduplication. In particular, the present disclosure overcomes current methods in data management by providing an improved method for efficient data management by solving the problem of reference data set management and construction. Still more particularly, the present disclosure provides additional improvements to the solution provided in the present disclosure that enables entities to sustain data within their backup storage while minimizing costs, storage space and power.

The present disclosure distinguishes from prior implementations by at least solving the following problems: computing similarity-based matching in storage applications; applying in a unique manner compression and deduplication to incoming data blocks; solving the problem of changing reference data sets that depend on altering data streams by using generational reference data set storage; and integrating reference data set management with garbage collection for space and run-time efficiency in storage devices such as, but not limited to, flash storage devices.

Furthermore, similarity-based deduplication algorithms operate by deducing an abstract representation of content associated with reference data blocks. Thus, reference data blocks can be used as templates for deduplicating other (i.e., future) incoming data blocks, leading to a reduction in total volume of data being stored. When deduplicated data blocks are recalled from storage, the reduced (e.g., deduplicated) representation can be retrieved from the storage and combined with information supplied by the reference data block(s) to reproduce the original data block.

The reference data blocks represent the data stream in abstract, therefore, as the nature of the data stream changes over time, the set of reference data blocks also changes. Over time a portion of the reference data blocks cease to be associated with a reference data set, while new data blocks are added to the reference data set, which leads to generation of a new reference data set. The data reduction achieved by the deduplication system can be used as a metric to evaluate whether the reference data set is a good representation of the incoming data stream. For instance, this can be done by having each deduplicated data block record the reference data block(s) against which it was encoded (e.g. reduced). The record can then be used so that on subsequent recalls of the stored data block, it can be correctly assembled back into original form promptly. This presents a requirement that the reference data blocks remain available as long as at least one data block potentially requires them for reconstruction. The requirement can have a number of consequences. First, a current set of reference data blocks can change over time in response to the data stream being presented for storage; however, it is possible that past reference data blocks remain in use by only a small subset of stored data blocks of a reference data set. Second, the collection of all reference data blocks employed by a storage device continuously grows over the life of the device. This leads to an unbounded growth of the collection over a multi-year life span of the storage devices. The unbounded growth is not feasible in association to storing all data on the storage device at all times due to the nature of flash storage devices. While flash storage devices are superior in speed and random read access compared to traditional storage devices and hard drives, flash storage devices have storage capacity limitations and endurance reduction over the life span. The endurance reduction in flash storage devices is associated with the tolerance for write-erase cycles by the flash storage device, while performance of the flash storage device is impacted by the availability of free writeable data blocks in the flash storage device.

A method for retiring old reference data blocks that are no longer useful needs to be applied. The method may include a reference count associated with reference data blocks by tracking the number of times data blocks rely on a reference data block and/or set of reference data blocks such that it can be determined when a reference data block is no longer relied upon by a data block and can therefrom be retired from the set. Also, as a new data block is added to storage the reference count needs to be incremented to reflect a use count of that reference data block and/or reference data set. Similarly, when a data block is deleted (or overwritten) the use count needs to be decremented of a corresponding reference data block and/or reference data set. It is essential that the use counts be correctly synchronized and reliably persisted to guard against device shutdown or power failure.

A. Reference Block Aggregating into a Reference Set for Deduplication in Memory Management

One method of implementing reference data block aggregation into a reference data set can be performed by aggregating reference data blocks that share a degree of similarity into a reference data set. The reference data set may require a predefined number of data blocks for deduplication algorithms to execute properly. For instance, deduplication algorithms require having some number of reference data blocks (e.g. 10,000) to perform data encoding/reduction. Thus, instead of functioning with each reference data block independently, the present disclosure works with a reference data set that includes one or more data blocks (e.g. reference data blocks).

The reference data sets may have the following characteristics: 1) a reference data set can be used to run a deduplication algorithm actively for a period of time and 2) as a data stream changes, a new reference data set can be created/generated. However, the previous reference data set that is no longer used actively can be retained, because previously stored data blocks rely on this reference data set for data recall. Next, 3) use counts can be maintained against a reference data set and not against each reference data block. This in return can reduce management overhead of use counts, significantly. Lastly, 4) once a reference data set comes into existence, it can be retired after the use count drops to zero (i.e., no data blocks rely on it any longer).

In some embodiments, depending upon resource constraints of the system, data blocks of reference data set can be customized to include a predefined number of data blocks in the reference data set as well as a maximum number of reference data sets. In further embodiments, the system can comprise a clustered system, in which multiple different reference data sets are shared across the cluster to get a wider coverage.

### B. Pipelined Reference Set Construction and Use in Memory Management

Pipelined reference data set construction and usage can be implemented by performing overlapping construction and use of reference data sets. For example, while a current reference data set is being used to deduplicate an incoming data stream (e.g. series of data blocks); a new reference data set can be constructed in parallel. The present disclosure does not require that the new reference data set be started afresh, instead the new reference data set can be constructed using a popular subset of reference data blocks in the current reference data set, while adding new reference data blocks constructed in response to changes in the data stream. This way, when a deduplication algorithm deems that the current reference data set is no more effective, it can start using the new reference data set. The two innovative reference data set management techniques as described above can be used and integrated with deduplication in flash management storage.

C. Integration of Reference Sets with Segment Flash Management

One embodiment of implementing the present disclosure with flash management can be performed by aggregating data blocks that rely on a reference data set into a segment. The segment refers to a chunk of flash storage that can be filled sequentially and erased as a unit. Each data block can be associated with the reference data set (and specific reference data blocks within them) and can be relied on for data recall. Thus, instead of tracking use of a reference data block by each incoming data block individually, the system can track the use of a reference data set (i.e. group of reference data blocks). In flash-based storage systems, incoming data blocks are written sequentially to flash, thus, there is a special locality among data blocks that are written close in time. In some embodiments, a segment can refer to multiple (e.g. 2) reference data sets in memory of flash storage.

Furthermore, a segment can be tagged with an identifier (e.g. reference data set identifier), and therefrom the system can track which segments are using which reference data sets. This can lead to substantial efficiency—the volume of information can be reduced by three orders of magnitude (each segment hosts thousands of data blocks) and since segment level management is already inherent to flash management, the extra burden to track an additional piece of information (reference set usage) is minimal. Therefore, reference data sets are compactly represented via a simple integer identifier, and reference data sets can be used by various data segments (not individual data blocks) and tracked compactly. In one embodiment, the system uses 16 sets that may include 16,384 reference data blocks each. A reference data block can be 4 KB (kilobyte) in size and an identifier (e.g., reference data set identifier) can be 4-bits in size. The identifier can be associated with each segment of flash, which is 256 MB in size. This allows for space efficient and low overhead management of reference data sets.

### D. Garbage Collection for Reference Sets in Flash Storage Systems

In some embodiments, implementing the present disclosure with flash management and garbage collection can be performed as described below. At the time of garbage collection, valid data blocks are moved to a new location in flash storage. It is important to note, that data blocks in a flash segment are filled sequentially and use the same reference data set. As the garbage collection algorithm works on each segment of flash memory, the garbage collection algorithm makes one of the following two decisions for data blocks contained therein. These decisions can be based on a state of the reference data set (e.g. reference data set R) associated with the segment. The decision that the garbage collection algorithm makes can be: 1) if a reference data set (e.g. reference data set R) continues to be available, then move reduced data blocks to a new location in flash memory, and/or 2) if a reference data set (e.g. reference data set R) is expected to be retired soon, then reconstruct original data blocks using the reference data set (e.g. R) and newly deduplicate it using a newer reference data set(s). As a result, once the reference data set (e.g. R) is put on a path to retirement, a use count of the reference data set (e.g. R) will steadily decrease, and once it reaches zero (i.e., no active users remain) R can be retired and its corresponding identifier becomes available for reuse.

In some embodiments, when a reference data set is ready for retirement the garbage collection algorithm can force the reference data set to retire faster using a garbage collection algorithm. In further embodiments, the present disclosure can perform statistical analyses on the population of data blocks to determine popular reference data sets and use them to tune the reference data set selection algorithms.

Thus, the present disclosure provides integration between reference data set tracking and flash management—per segment reference data set to improve storage and processing overhead of reference data set information. Also, integration between reference data set handling and garbage collection enables the system to retire older reference data sets and to track reference data set usage across the entire storage device for optimizing data movement by deciding at runtime whether to copy reduced data blocks as-is or to re-reduce them using a different reference data set.

### System

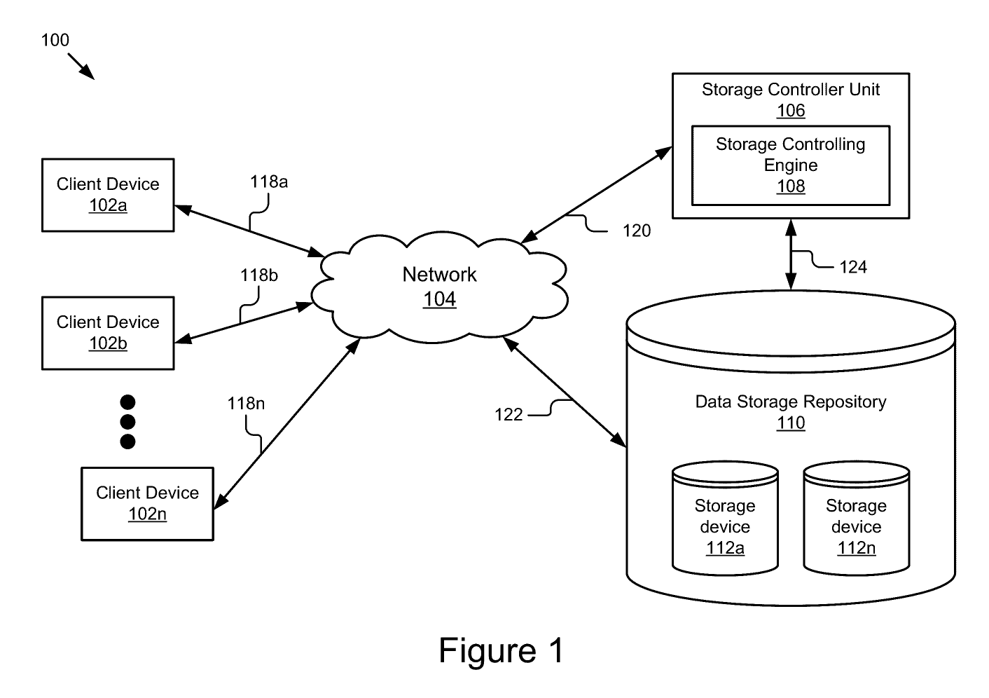

FIG. 1 is a high-level block diagram illustrating an example system for managing reference data blocks in a reference data set in a storage device. In the depicted embodiment, the system 100 may include client devices 102a, 102b through 102n, a storage controller unit 106, and a data storage repository 110. In the illustrated embodiment, these entities of the system 100 are communicatively coupled via network 104. However, the present disclosure is not limited to this configuration and a variety of different system environments and configurations may be employed and are within the scope of the present disclosure. Other implementations may include additional or fewer computing devices, services and/or networks. It should be recognized that FIG. 1 as well as the other figures used to illustrate an embodiment, an indication of a letter after a reference number or numeral, for example, “102a” is a specific reference to the element or component that is designated by that particular reference numeral. In the event a reference numeral appears in the text without a letter following it, for example, “102”, it should be recognized that such is a general reference to different embodiments of the element or component bearing that general reference numeral.

In some embodiments, the entities of the system 100 may use a cloud-based architecture where one or more computer functions or routines are performed by remote computing systems and devices at the request of a local computing device. For example, a client device 102 can be a computing device having hardware and/or software resources and may access hardware and/or software resources provided across the network 104 by other computing devices and resources, including, for instance, other client devices 102, the storage controller unit 106 and/or the data storage repository 110, or any other entities of the system 100.

The network 104 can be a conventional type, wired or wireless, and may have numerous different configurations including a star configuration, token ring configuration, or other configurations. Furthermore, the network 104 may include a local area network (LAN), a wide area network (WAN) (e.g., the internet), and/or other interconnected data paths across which multiple devices (e.g., storage controller unit 106, client device 102, etc.) may communicate. In some embodiments, the network 104 may be a peer-to-peer network. The network 104 may also be coupled with or include portions of a telecommunications network for sending data using a variety of different communication protocols. In further embodiments, the network 104 may include Bluetooth™ (or Bluetooth low energy) communication networks or a cellular communications network for sending and receiving data including via short messaging service (SMS), multimedia messaging service (MMS), hypertext transfer protocol (HTTP), direct data connection, WAP, email, etc. Although the example of FIG. 1 illustrates one network 104, in practice one or more networks 104 can connect the entities of the system 100.

In some embodiments, the client devices 102 (any or all of 102a, 102b through 102n) are computing devices having data processing and data communication capabilities. In the illustrated embodiment, the client devices 102a, 102b through 102n are communicatively coupled to the network 104 via signal lines 118a, 118b through 118n respectively. The client devices 102a, 102b through 102n can be any computing device including one or more memory and one or more processors, for example, a laptop computer, a desktop computer, a tablet computer, a mobile telephone, a personal digital assistant (PDA), a mobile email device, a portable game player, a portable music player, a television with one or more processors embedded therein or coupled thereto or any other electronic device capable of making storage requests. A client device 102 may execute an application that makes storage requests (e.g., read, write, etc.) to the data storage repository 110. Client devices may be directly coupled with the data storage repository 110 including individual storage devices (e.g., storage device 112a through 112 n) (not shown).

The client device 102 may also include one or more of a graphics processor; a high-resolution touchscreen; a physical keyboard; forward and rear facing cameras; a Bluetooth® module; memory storing applicable firmware; and various physical connection interfaces (e.g., USB, HDMI, headset jack, etc.); etc. Additionally, an operating system for managing the hardware and resources of the client device 102, application programming interfaces (APIs) for providing applications access to the hardware and resources, a user interface module (not shown) for generating and displaying interfaces for user interaction and input, and applications including, for example, applications for manipulating documents, images, e-mail(s), and applications for web browsing, etc., may be stored and operable on the client device 102. While the example of FIG. 1 includes three client devices, 102a, 102b, and 102n, it should be understood that any number of client devices 102 may be present in the system.

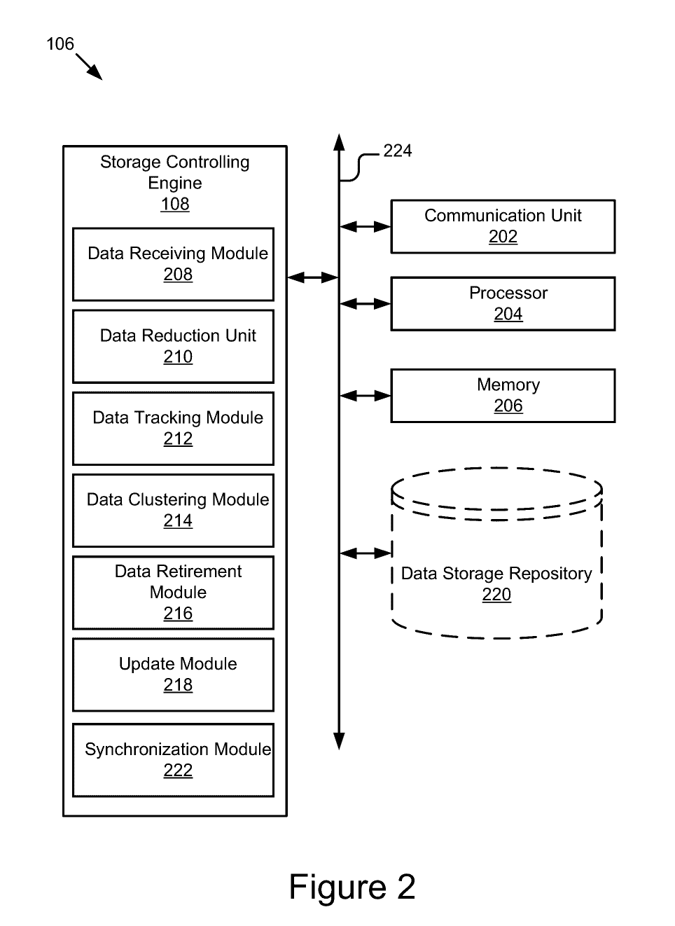

The storage controller unit 106 can be hardware that includes a (micro) processor, a memory, and network communication capabilities, for example, as described in more detail below with reference to FIG. 2. The storage controller unit 106 is coupled to the network 104 via signal line 120 for communication and cooperation with the other components of the system 100. In some embodiments, the storage controller unit 106 sends and receives data to and from one or more of the client devices 102a, 102b through 102n, and/or the data storage repository 110 via the network 104. In one embodiment, the storage controller unit 106 directly sends and receives data to and from the data storage repository 110 and/or storage devices 112a through 112n, via signal line 124. Although, one storage controller unit is shown, it should be recognized that multiple storage controller units can be utilized, either in a distributed architecture or otherwise. For the purpose of this application, the system configuration and operations performed by the system are described in the context of a single storage controller unit 106.

In some embodiments, the storage controller unit 106 may include a storage-controlling engine 108 for providing efficient data management. The storage-controlling engine 108 can provide computing functionalities, services, and/or resources to send, receive, read, write, and transform data from other entities of the system 100. It should be understood that the storage-controlling engine 108 is not limited to providing the above-noted functions. In various embodiments, the storage devices 112 may be directly connected with the storage controller unit 106 or may be connected through a separate controller (not shown) and/or via the network 104 by signal line 122. The storage controller unit 106 can be a computing device configured to make some or all of the storage space available to client devices 106. As depicted in the example system 100, client devices 102 can be coupled to the storage controller unit 106 via network 104 or directly (not shown).

Furthermore, the client devices 102 and storage controller unit 106 of system 100 can include additional components, which are not shown in FIG. 1 to simplify the drawing. Also, in some embodiments, not all of the components shown are present. Further, the various controllers, blocks, and interfaces can be implemented in any suitable fashion. For example, a storage controller unit can take the form of one or more of, for example, a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller.

The data storage repository 110 and optional data storage repository 220 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with a processor. While the present disclosure refers to the data storage repository 110/220 as flash memory, it should be understood that in some embodiments, the data storage repository 110/220 may include a non-transitory memory such as a dynamic random access memory (DRAM) device, a static random access memory (SRAM) device, or some other memory devices. In some embodiments, data storage repository 110/220 may also include a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device.

FIG. 2 is a block diagram illustrating an example of the storage controller unit 106 configured to implement the techniques described herein. As depicted, the storage controller unit 106 may include a communication unit 202, a processor 204, a memory 206, a data storage repository 220, and the storage-controlling engine 108, which may be communicatively coupled by a communication bus 224. It should be understood that the above configurations are provided by way of example and numerous further configurations are contemplated and possible.

The communication unit 202 may include one or more interface devices for wired and wireless connectivity with the network 104 and the other entities and/or components of the system 100 including, for example, the client devices 102 and the data storage repository 110, etc. For instance, the communication unit 202 may include, but is not limited to, CAT-type interfaces; wireless transceivers for sending and receiving signals using Wi-Fi™; Bluetooth®, cellular communications, etc.; USB interfaces; various combinations thereof; etc. In some embodiments, the communication unit 202 can link the processor 204 to the network 104, which may in turn be coupled to other processing systems. The communication unit 202 can provide other connections to the network 104 and to other entities of the system 100 using various standard communication protocols, including, for example, those discussed elsewhere, herein.

The processor 204 may include an arithmetic logic unit, a microprocessor, a general-purpose controller, or some other processor array to perform computations and provide electronic display signals to a display device. In some embodiments, the processor 204 is a hardware processor having one or more processing cores. The processor 204 is coupled to the bus 224 for communication with the other components. Processor 204 processes data signals and may include various computing architectures including a complex instruction set computer (CISC) architecture, a reduced instruction set computer (RISC) architecture, or an architecture implementing a combination of instruction sets. Although only a single processor is shown in the example of FIG. 2, multiple processors and/or processing cores may be included. It should be understood that other processor configurations are possible.

The memory 206 stores instructions and/or data that may be executed by the processor 204. In some embodiments, the memory 206 may store instructions and/or data that may be executed by the processor 204. The memory 206 is also capable of storing other instructions and data, including, for example, an operating system, hardware drivers, other software applications, databases, etc. The memory 206 may be coupled to the bus 224 for communication with the processor 204 and the other components of the system 100.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204. In some embodiments, the memory 206 may include a non-transitory memory such as a dynamic random access memory (DRAM) device, a static random access memory (SRAM) device, flash memory, or some other memory devices. In some embodiments, the memory 206 also includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device.

The bus 224 may include a communication bus for transferring data between components of a computing device or between computing devices, a network bus system including the network 104 or portions thereof, a processor mesh, a combination thereof, etc. In some embodiments, the client devices 102 and the storage controller unit 106 may cooperate and communicate via a software communication mechanism implemented in association with the bus 224. The software communication mechanism may include and/or facilitate, for example, inter-process communication, local function or procedure calls, remote procedure calls, network-based communication, secure communication, etc.

The storage-controlling engine 108 is software, code, logic, or routines for providing efficient data management. As depicted in FIG. 2, the storage-controlling engine 108 may include a data receiving module 208, a data reduction unit 210, a data tracking module 212, a data clustering module 214, a data retirement module 216, an update module 218 and a synchronization module 222.

In some embodiments, the components 208, 210, 212, 214, 216, 218 and/or 222 are electronically communicatively coupled for cooperation and communication with each other, the communication unit 202, the processor 204, the memory 206 and/or the data storage repository 220. These components 208, 210, 212, 214, 216, 218 and 222 are also coupled for communication with the other entities (e.g. client devices 102, storage devices 112) of the system 100 via the network 104. In some embodiments, the data receiving module 208, the data reduction unit 210, the data tracking module 212, the data clustering module 214, the data retirement module 216, the update module 218 and the synchronization module 222 are sets of instructions executable by the processor 204, or logic included in one or more customized processors, to provide their respective functionalities. In other embodiments, the data receiving module 208, the data reduction unit 210, the data tracking module 212, the data clustering module 214, the data retirement module 216, the update module 218 and the synchronization module 222 are stored in the memory 206 and are accessible and executable by the processor 204 to provide their respective functionalities. In any of these embodiments, the data receiving module 208, the data reduction unit 210, the data tracking module 212, the data clustering module 214, the data retirement module 216, the update module 218 and the synchronization module 222 are adapted for cooperation and communication with the processor 204 and other components of the computing device 200.

In one embodiment, the data receiving module 208 receives incoming data and/or retrieves data, the data reduction unit 210 reduces/encodes a data stream, the data tracking module 212 tracks data across system 100, the data clustering module 214 clusters reference data sets including data blocks, the data retirement module 216 retires data blocks and/or reference data sets including data blocks using garbage collection, the update module 218 updates information associated with a data stream, and the synchronization module 222 provides reliability to the one or more other components of the storage controller unit 106. The particular naming and division of the modules, routines, features, attributes, methodologies and other aspects are not mandatory or significant, and the mechanisms that implement the present invention or its features may have different names, divisions and/or formats.

The data-receiving module 208 is software, code, logic, or routines for receiving incoming data and/or retrieving data. In one embodiment, the data-receiving module 208 is a set of instructions executable by the processor 204. In another embodiment, the data-receiving module 208 is stored in the memory 206 and is accessible and executable by the processor 204. In either embodiment, the data-receiving module 208 is adapted for cooperation and communication with the processor 204 and other components of the computing device 200 including other components of a data reduction unit 210.

The data-receiving module 208 receives incoming data and/or retrieves data from one or more data stores such as, but not limited to, data storage repository 110/220 of the system 100. Incoming data may include, but is not limited to, a data stream. In some embodiments, the data-receiving module 208 receives a data stream from a client device 102. The data stream may include a set of data blocks (e.g., current data blocks of a new data stream, reference data blocks from storage, etc.). The set of data blocks (e.g. of the data stream) can be associated with but are not limited to, documents, files, e-mails, messages, blogs, and/or any applications executed and rendered by the client device 102 and/or stored in memory. Furthermore, the set of data blocks may include user readable files such as those executed and rendered via application on client devices such as, spreadsheet applications, forms, magazines, articles, books, contact details, databases, portions of databases, tables, etc. In other embodiments, the data stream can be associated with a set of data blocks (e.g. reference data blocks) retrieved from a data store, such as, data storage repository 220 and/or a flash storage device (not shown).

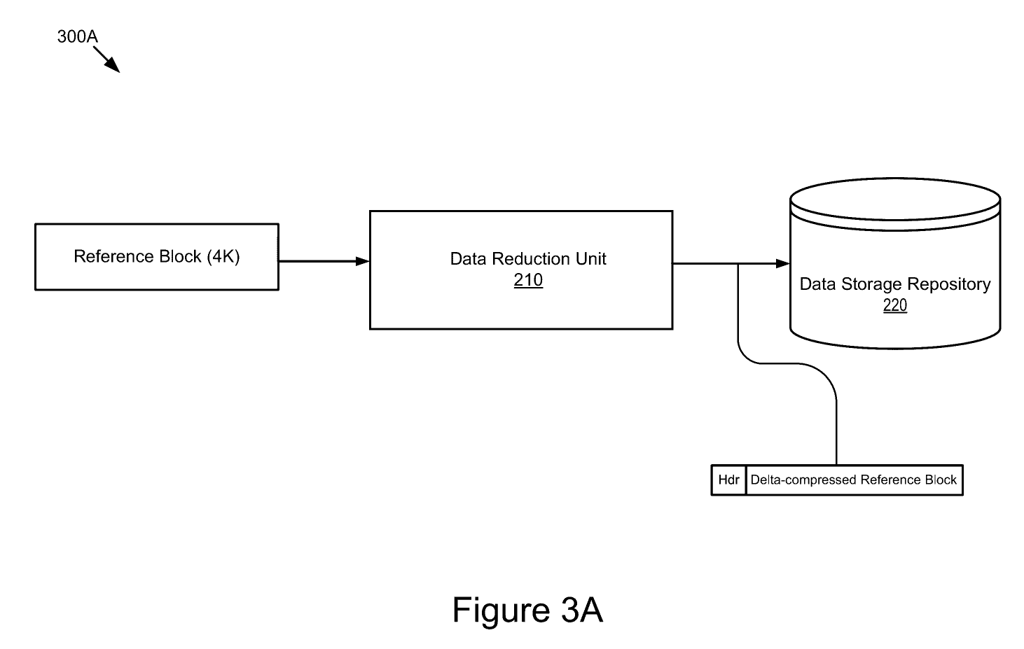

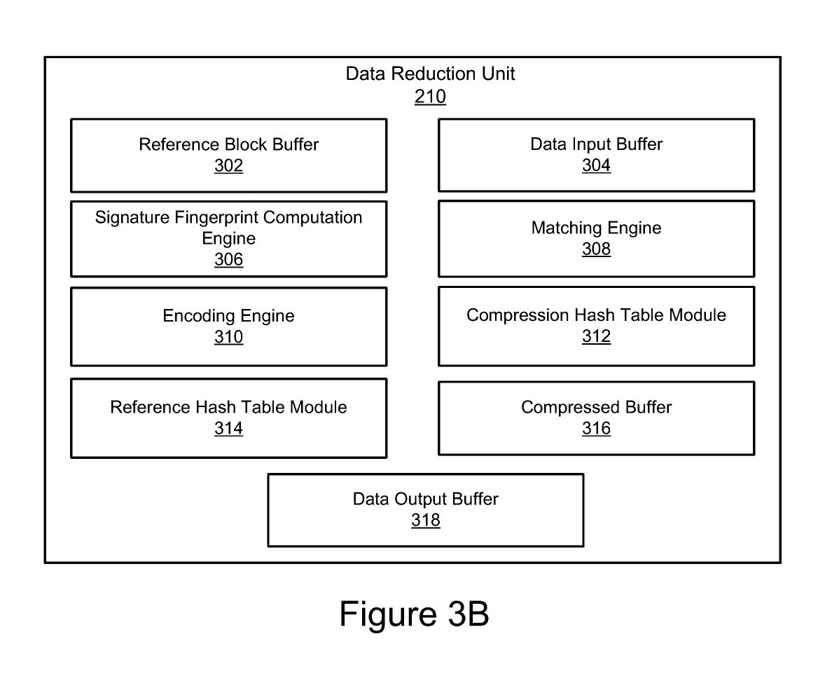

The data reduction unit 210 is software, code, logic, or routines for reducing/encoding a data stream, as discussed further elsewhere herein. In one embodiment, the data reduction unit 210 is a set of instructions executable by the processor 204. In another embodiment, the data reduction unit 210 is stored in the memory 206 and is accessible and executable by the processor 204. In either embodiment, the data reduction unit 210 is adapted for cooperation and communication with the processor 204 and other components of the computing device 200. In further embodiments, the data reduction unit 210 may include a reference block buffer 302, a data input buffer 304, a signature fingerprint computation engine 306, a matching engine 308, an encoding engine 310, a compression hash table module 312, a reference hash table module 314, a compressed buffer 316, and a data output buffer 318, as depicted in FIG. 3B.

The data-tracking module 212 is software, code, logic, or routines for tracking data. In one embodiment, the data-tracking module 212 is a set of instructions executable by the processor 204. In another embodiment, the data-tracking module 212 is stored in the memory 206 and is accessible and executable by the processor 204. In either embodiment, the data-tracking module 212 is adapted for cooperation and communication with the processor 204 and other components of the computing device 200 including other components of the data reduction unit 210.

The data-tracking module 212 may track data blocks from one or more data stores of the system 100, that may include, but is not limited to, exclusively storage devices 112 of data storage repository 110, memory (not shown) of client devices 102, and/or data storage repository 220. In some embodiments, the data-tracking module 212 can track counts associated with data blocks across the system 100. The counts can be tracked by the data-tracking module 212 by tracking the number of times one or more data blocks rely on a reference data block and/or a reference data set. Furthermore, the data-tracking module 212 can transmit the counts tracked to one or more other components of the computing device 200 for determining when a reference data block of a reference data set is no longer relied upon by a data block and can therefrom be retired. In one embodiment, the data-tracking module 212 tracks segments of memory associated with a non-transitory data store (e.g. flash memory, data storage repository 110/220) for data recall by one or more client devices 102. For example, a client device 102 may be rendering one or more applications and request accesses to content associated with a segment including data blocks (e.g. set of data blocks) stored in non-transitory data store (i.e. in flash memory), the data tracking module 212 may then track the number of times a segment and/or reference data set is called back upon (i.e. data recalled) to render one or more contents associated with the request, as discussed in more detail elsewhere herein.

The data-clustering module 214 is software, code, logic, or routines for clustering reference data sets. In one embodiment, the data-clustering module 214 is a set of instructions executable by the processor 204. In another embodiment, the data-clustering module 214 is stored in the memory 206 and is accessible and executable by the processor 204. In either embodiment, the data-clustering module 214 is adapted for cooperation and communication with the processor 204 and other components of the computing device 200 including other components of the data reduction unit 210.

In some embodiments, the data clustering module 214 in cooperation with one or more other components of the computing device 200 determines a dependency of one or more data blocks to one or more reference data sets stored in segments of a corresponding memory such as, a non-transitory flash data store (e.g. flash memory that can be one or more storage devices 112). A dependency of one or more data blocks to one or more reference data sets may reflect a common reconstruction/encoding dependency of one or more data blocks to one or more reference data sets for call back. For instance, a data block (i.e. an encoded data block) may rely on a reference data set for reconstructing the original data block such that the original information associated with the original data block (un-encoded data block) can be provided for presentation to a client device (e.g. client device 102).

In further embodiments, the data-clustering module 214 identifies one more differentiating reference data sets relied on by a plurality of data block across client devices 102. The data-clustering module 214 can generate a cluster based on the one or more reference data sets, such that the differentiating reference data sets are shared across the cluster to get a wider coverage. In one embodiment, the differentiating reference data sets can be reference data sets that are frequently data recalled (e.g. data recalled above a minimum, maximum, and/or range of threshold(s)) by data blocks of the system 100.

The data retirement module 216 is software, code, logic, or routines for retiring reference data sets. In one embodiment, the data retirement module 216 is a set of instructions executable by the processor 204. In another embodiment, the data retirement module 216 is stored in the memory 206 and is accessible and executable by the processor 204. In either embodiment, the data retirement module 216 is adapted for cooperation and communication with the processor 204 and other components of the computing device 200 including other components of the data reduction unit 210.

The data retirement module 216 may determine whether one or more reference data sets stored in one or more data stores, such as but not limited to, data storage 110/220 satisfy for retirement. In one embodiment, a reference data set satisfies for retirement based on a use count variable (e.g. reference count). For instance, a reference data set can satisfy for retirement when a corresponding use count variable decrements to a particular threshold value.

In some embodiments, a reference data set satisfies for retirement when a count of the use count variable of the reference data set decrements to zero. A use count variable of zero may indicate that no data blocks or sets of data blocks rely on a (e.g. reference to a) corresponding stored reference data set for regeneration. For example, an incoming data stream includes no encoded data blocks (e.g. compressed/deduped data blocks) that rely on a reference data set for reconstruction (i.e. un-encoding). In further embodiments, the data retirement module 216 may force a reference data set to retire based on the use count variable. For instance, a reference data set may result to a certain count and after reaching the certain count, the data retirement module 216 can force the reference data set to retiring by applying a garbage collection algorithm (and/or any other algorithm well-known in the art for data storage cleanup) on the reference data set. Additional operations of the data retirement module 216 are discussed elsewhere herein.

The update module 218 is software, code, logic, or routines for updating information associated with a data stream. In one embodiment, the update module 218 is a set of instructions executable by the processor 204. In another embodiment, the update module 218 is stored in the memory 206 and is accessible and executable by the processor 204. In either embodiment, the update module 218 is adapted for cooperation and communication with the processor 204 and other components of the computing device 200 including other components of the data reduction unit 210.

The update module 218 can receive data blocks and update one or more identifiers associated with the data block in a records table stored in a data store (e.g. data storage repository 110/220). A records table may include, but is not limited to, a table with rows and columns stored in a database, indexing table, etc. In one embodiment, the received data blocks can be encoded/reduced data blocks. In further embodiments, the update module 218 may update an identifier associated with a reference data set. An identifier may include, but is not limited to, a pointer. A pointer can be associated with data blocks and/or reference data sets and may include additional information such as, but not limited to, global information about the data blocks and/or the reference data set. In some embodiments, the pointer may include information such as a total number of data blocks pointing to a particular reference data set in storage.

In one embodiments, the update module 218 receives from the data-tracking module 212 information associated with a data recall from a client device. The data recall can be associated with one or more reference data sets in memory of a segment of data storage. The update module 218 may then update a segment header (e.g. identifier) associated with the reference data set of the segment associated with the data recall. In further embodiments, the update module 218 updates a portion of the segment header that may include, information such as the number of times the segment has been data recalled. Additional operations of the update module 218 are discussed elsewhere herein.

The synchronization module 222 can be software, code, logic, or routines for providing reliability to the one or more other components of the storage controller unit 106 such as, but not limited to, the data receiving module 208, the data reduction unit 210, the data tracking module 212, the data clustering module 214, the data retirement module 216 and the update module 218. In one embodiment, the synchronization module 222 is a set of instructions executable by the processor 204. In another embodiment, the synchronization module 222 is stored in the memory 206 and is accessible and executable by the processor 204. In either embodiment, the synchronization module 222 is adapted for cooperation and communication with the processor 204 and other components of the storage controller unit 106 including other components of the data reduction unit 210.

In one embodiment, the synchronization module 222 can guard against data interruption such as during device shutdowns (e.g. client device shutdown) and/or power failures during receiving, retrieving, encoding, updating, modifying, and/or storing data by one or more components of the storage controller unit 106. For instance, the synchronization module 222 may provide reliability to the update module 218, while the update module 218 is updating/modifying a use count variable (e.g. reference count) associated with a data/reference block and/or reference data set. In further embodiments, the synchronization module 222 may work in parallel with one or more buffers of the data reduction unit 210. For example, the synchronization module 222 may transmit a data stream to the data input buffer 304 to store data blocks of the data stream temporarily in case of a power failure occurring in the system 100 during processing, the data blocks of the data stream would not be compromised.

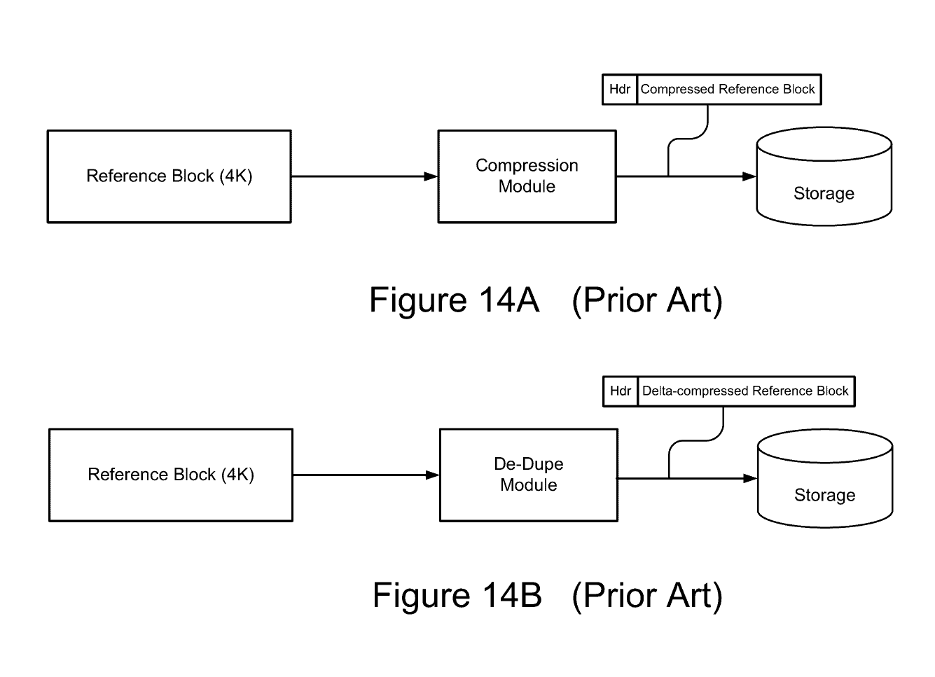

FIG. 3A is a block diagram 300A illustrating an example hardware efficient data management system configured to implement the techniques introduced here. As depicted in FIG. 3A the data reduction unit 210 receives a reference block, processes the reference block and outputs a encoded/reduced version of the reference block and stores the encoded reference data block in the data storage repository 220. Furthermore, the depicted illustration in FIG. 3A incorporates key points of the present disclosure that include but is not limited to, similarity-based content matching for storage applications and data deduplication. Similarity based content matching can be applied across multiple documents for detecting and identifying similarity between one or more documents, as opposed to identifying an exact match among a set of documents. The present disclosure distinguishes from prior implementations (as shown in FIGS. 14A and 14B) by at least solving the following problems: 1) using similarity-based matching in storage applications, 2) applying in a unique manner compression and deduplication to data blocks, 3) solving the problem of changing reference data sets that depend on altering data streams (traffic) by using generational reference data set storage and 4) integrating reference data set management with garbage collection for space and run-time efficiency in storage devices such as, flash storage devices.

FIG. 3B is a block diagram illustrating an example data reduction unit 210 configured to implement the techniques described herein. As depicted in FIG. 3, the data reduction unit 210 may include the reference block buffer 302, the data input buffer 304, the signature fingerprint computation engine 306, the matching engine 308, the encoding engine 310, the compression hash table module 312, the reference hash table module 314, the compressed buffer 316 and the data output buffer 318.

In some embodiments, the components 302, 304, 306, 308, 310, 312, 314, 316, and 318 are electronically communicatively coupled for cooperation and communication with each other, the communication unit 202, the processor 204, the memory 206, and/or the data storage repository 220. These components 302, 304, 306, 308, 310, 312, 314, 316, and 318 are also coupled for communication with the other entities (e.g. client devices 102) of the system 100 via the network 104. In further embodiments, the reference block buffer 302, the data input buffer 304, the signature fingerprint computation engine 306, the matching engine 308, the encoding engine 310, the compression hash table module 312, the reference hash table module 314, the compressed buffer 316, and the data output buffer 318 are sets of instructions executable by the processor 204, or logic included in one or more customized processors, to provide their respective functionalities. In other embodiments, the reference block buffer 302, the data input buffer 304, the signature fingerprint computation engine 306, the matching engine 308, the encoding engine 310, the compression hash table module 312, the reference hash table module 314, the compressed buffer 316, and the data output buffer 318 are stored in the memory 206 and are accessible and executable by the processor 204 to provide their respective functionalities. In any of these embodiments, the reference block buffer 302, the data input buffer 304, the signature fingerprint computation engine 306, the matching engine 308, the encoding engine 310, the compression hash table module 312, the reference hash table module 314, the compressed buffer 316, and the data output buffer 318 are adapted for cooperation and communication with the processor 204 and other components of the computing device 200.

The reference block buffer 302 is logic or routines for storing a data stream tentatively. In one embodiment, the reference block buffer 302 is a set of instructions executable by the processor 204. In another embodiment, the reference block buffer 302 is stored in the memory 206 and is accessible and executable by the processor 204. In either embodiment, the reference block buffer 302 is adapted for cooperation and communication with the processor 204 and other components of the computing device 200 including other components of the data reduction unit 210.

In one embodiment, the storage-controlling engine 108 retrieves reference data blocks from the data storage repository 220 for manipulating and processing the reference data blocks. The storage-controlling engine 108 may then transmit the reference data blocks to the reference block buffer 302 for provisional storing. Storing the reference data blocks in the reference block buffer 302 tentatively provides the system rate stability between retrieving the reference data blocks and processing of the reference data blocks. In one embodiment, the storage-controlling engine 108 retrieves a reference data set from the data storage repository 220 for processing the reference data set in cooperation with one or more components of the computing device 200. Prior to processing the reference data set, the storage-controlling engine 108 and/or one or more other components of the computing device 200 may transmit the reference data set to the reference block buffer 302 for tentative storing. The reference block buffer 302 can be a queue that may include one or more reference data blocks and/or one or more reference data sets in queue for processing by one or more components of the computing device 200.

The data input buffer 304 is logic or routines for tentatively storing one or more data blocks of an incoming data stream. In one embodiment, the data input buffer 304 is a set of instructions executable by the processor 204. In another embodiment, the data input buffer 304 is stored in the memory 206 and is accessible and executable by the processor 204. In either embodiment, the data input buffer 304 is adapted for cooperation and communication with the processor 204 and other components of the computing device 200 including other components of the data reduction unit 210.

In one embodiment, the storage-controlling engine 108 receives one or more data blocks from a client device (e.g. client devices 10) for processing the data blocks of the incoming data stream. The storage-controlling engine 108 may then transmit the received data blocks to the data input buffer 304 for provisional storing. Storing of the data blocks in the data input buffer 304 tentatively provides the system processing efficiency between receiving data blocks and processing of the data blocks. In particular, if the processing rate of the storage controlling engine 108 is increased (e.g. by a magnitude) in response to receiving several incoming data streams from a plurality of client devices, the data input buffer may act as a queue schedule. For instance, the data input buffer 304 may include the queue schedule that queues one or more data blocks associated with a plurality of client devices such that, the storage controlling engine 108 processes the data blocks based on the data blocks corresponding position in the queue schedule.

The signature fingerprint computation engine 306 is software, code, logic, or routines for generating and analyzing identifiers of data blocks associated with a data stream. In one embodiment, the signature fingerprint computation engine 306 is a set of instructions executable by the processor 204. In another embodiment, the signature fingerprint computation engine 306 is stored in the memory 206 and is accessible and executable by the processor 204. In either embodiment, the signature fingerprint computation engine 306 is adapted for cooperation and communication with the processor 204 and other components of the computing device 200 including other components of the data reduction unit 210.

In one embodiment, the signature fingerprint computation engine 306 receives a data stream including one or more data blocks for analysis. The signature fingerprint computation engine 306 may generate an identifier for each of the one or more data blocks of the data stream. In some embodiments, the signature fingerprint computation engine 306 may generate a reference identifier for a reference data set that includes one or more reference data blocks. The identifier may include information such as, but not limited to, fingerprints and/or digital signatures associated with each data block of the data stream.

The signature fingerprint computation engine 306 may analyze information associated with the identifier information (e.g., digital signatures, fingerprints, etc.) of the data blocks associated with an incoming data stream by parsing a data store (e.g. data storage repository 110, 220) for one or more reference data blocks and/or reference data sets (i.e. reference data set including one or more reference data blocks) that matches to the data blocks of the incoming data stream, as discussed elsewhere herein. For example, the signature fingerprint computation engine 306 generates fingerprints for data blocks of an incoming data stream. The signature fingerprint computation engine 306 then analyze the fingerprints by parsing and comparing the fingerprints of the data blocks of the incoming data stream to one or more fingerprints associated with a plurality of reference data blocks and/or reference data sets stored in storage and determines if a match exists. In further embodiments, the signature fingerprint computation engine 306 may transmit results of the analysis to the matching engine 308 for further processing.

The matching engine 308 is software, code, logic, or routines for identifying similarities between data. In one embodiment, the matching engine 308 is a set of instructions executable by the processor 204. In another embodiment, the matching engine 308 is stored in the memory 206 and is accessible and executable by the processor 204. In either embodiment, the matching engine 308 is adapted for cooperation and communication with the processor 204 and other components of the computing device 200 including other components of the data reduction unit 210. Data may include, but is not limited to, one or more data blocks, reference data blocks, and/or reference data sets that can be associated with files, documents, e-mail messages rendered by applications via client devices.

In one embodiment, the matching engine 308 in cooperation with the signature fingerprint computation engine 306 applies a similarity-based algorithm to detect similarities between incoming data and data previously stored in storage. In some embodiments, the matching engine 308 identifies similarity between incoming data and data previously stored by comparing resemblance hashes (e.g. hash sketches) associated with the incoming data and the data previously stored in storage. A resemblance hash can be part of the information associated with an identifier generated by the fingerprint computation engine 306.

A similarity-based algorithm can be used to detect similarity between resemblance hashes of data blocks of an incoming data stream and resemblance hashes associated with reference data sets. In further embodiments, the resemblance hash may reflect a sketch of content associated with data block(s) and/or a reference data set. For instance, a sketch can be generated from maximal values within a reference data set/data block(s) that tend to persist if the reference data blocks of the reference data set and/or set of data blocks of an incoming data stream are slightly modified. Therefore, if the data blocks of an incoming data stream are similar based on corresponding resemblance hashes (e.g. hash sketches) to an existing reference data set, it can be transmitted to the encoding engine 310 for encoding the data blocks of the incoming data stream relative to the existing reference data set, as discussed elsewhere herein.

In other embodiments, the matching engine 308 applies a similarity-based algorithm to one or more reference data blocks stored in data store for generating a reference data set from the reference data blocks. For instance, if the reference data blocks in storage are similar between each other based on a criterion such as, corresponding resemblance hashes (e.g. hash sketches), the reference data blocks can be aggregated into a reference data set, as discussed elsewhere herein.

The encoding engine 310 is software, code, logic, or routines for encoding data. In one embodiment, the encoding engine 310 is a set of instructions executable by the processor 204. In another embodiment, the encoding engine 310 is stored in the memory 206 and is accessible and executable by the processor 204. In either embodiment, the encoding engine 310 is adapted for cooperation and communication with the processor 204 and other components of the computing device 200 including other components of the data reduction unit 210.

In one embodiment, the encoding engine 310 encodes data blocks associated with a data stream. The data stream can be associated with a file, wherein the data blocks of the data stream are content-defined chunks of the file. In some embodiments, the encoding engine 310 receives a data stream including data blocks and encodes each data block of the data stream by using a reference data set stored in a non-transitory data store, such as, but not limited to, data storage repository 110.

The encoding engine 310 in cooperation with one or more other components of the computing device 200 can determine a reference data set for encoding data blocks based on a similarity between information associated with identifiers of the reference data set and that of the data blocks. The identifier information may include information such as, content of the data blocks/reference data set, content version (e.g. revisions), calendar dates associated with modifications to the content, data size, etc. In further embodiments, encoding data blocks of a data stream may include applying an encoding algorithm to the data blocks of the data stream. A non-limiting example of an encoding algorithm, may include, but is not limited to, a deduplication /compression algorithm. In one embodiment, the encoding engine 310 may transmit the encoded data blocks of the data stream to the compressed buffer 316 and/or the data output buffer 318.

In other embodiments, the encoding engine 310 may encode a set of data blocks based on a reference data set while, concurrently generating a new reference data set including a subset of reference data blocks and a set of data blocks associated with a data stream. The subset of reference data blocks of the new reference data set can be associated with a corresponding reference data set currently stored in a data store, as discussed elsewhere herein.

The compression hash table module 312 is software, code, logic, or routines for updating information associated with encoded data blocks. In one embodiment, the compression hash table module 312is a set of instructions executable by the processor 204. In another embodiment, the compression hash table module 312 is stored in the memory 206 and is accessible and executable by the processor 204. In either embodiment, the compression hash table module 312 is adapted for cooperation and communication with the processor 204 and other components of the computing device 200 including other components of the data reduction unit 210.

In some embodiments, the compression hash table module 312 may include bucket arrays. The bucket arrays can be areas of storage associated with storage devices such as, flash storage that store data blocks, reference data blocks and reference data sets inside the bucket arrays. A bucket array can be an array with a finite size. In further embodiments, the compression hash table module 312 stores data using hash functions. The data may include but is not limited to, data blocks of an incoming data stream, reference data blocks of a reference data set, etc. The compression hash table module 312 in one embodiment uses a hash function algorithm on data for storing data in a hash table. In other embodiments, the hash table can be stored, retrieved, and maintained in storage such as, but not limited to data storage repository 110.

In one embodiment, the compression hash table module 312 may generate a reference data pointer (e.g. identifier) for an encoded data block, as discussed elsewhere herein. The reference data pointer associated with the encoded data block may reference to a corresponding reference data set stored in data store that was used to encode the data block. In further embodiments, the reference data pointer(s) can be maintained by one or more other components of system 100. Reference data pointer(s) associated with one or more encoded data blocks may be used latter for referencing and/or retrieving a corresponding reference data block and/or reference data set from storage (e.g. data storage repository 110) and used for reconstructing each data block and/or set of data blocks associated with a received data stream using the reference data set and/or reference data block.

The reference hash table module 314 is software, code, logic, or routines for updating information associated with reference data blocks. In one embodiment, the reference hash table module 314 is a set of instructions executable by the processor 204. In another embodiment, the reference hash table module 314 is stored in the memory 206 and is accessible and executable by the processor 204. In either embodiment, the reference hash table module 314 is adapted for cooperation and communication with the processor 204 and other components of the computing device 200 including other components of the data reduction unit 210.

In some embodiments, the reference hash table module 314 updates a records table stored in data storage repository 110, wherein the records table associates encoded data blocks to a corresponding reference data set. In other embodiments, the reference hash table 314 updates a pointer associated with a reference data set. The pointer associated with the reference data set may include information such as, but not limited to, global information about a reference data set and total number of data blocks pointing to the reference data set. Additional functions of the reference hash table module 314 are discussed throughout the present disclosure.

The compressed buffer 316 is logic or routines for storing a compressed data stream temporarily. In one embodiment, the compressed buffer 316 is a set of instructions executable by the processor 204. In another embodiment, the compressed buffer 316 is stored in the memory 206 and is accessible and executable by the processor 204. In either embodiment, the compressed buffer 316 is adapted for cooperation and communication with the processor 204 and other components of the computing device 200 including other components of the data reduction unit 210.

In one embodiment, the compression hash table module 312 retrieves encoded (e.g. compressed/reduced) reference data blocks from the encoding engine 310 for further processing of the encoded reference data blocks. In some embodiments, the encoding engine 310 may transmit the encoded reference data blocks to the compressed buffer 316 for temporary storage. Storing the encoded reference data blocks in the compressed buffer 316 temporarily provides the system stability between receiving the encoded reference data blocks and further processing of the encoded reference data blocks. In some embodiments, the encoding engine 310 encodes a reference data set and transmits the encoded reference data set to the compressed buffer 316. In other embodiments, the encoding engine 310 encodes one or more data blocks associated with a data stream and transmit the encoded data blocks to the compressed buffer 316 for temporary storage. The compressed buffer 316 can be a queue that may include one or more reference data blocks, reference data sets and/or data blocks in queue for processing by one or more components of the computing device 200.

The data output buffer 318 is logic or routines for storing a processed data stream temporarily. In one embodiment, the data output buffer 318 is a set of instructions executable by the processor 204. In another embodiment, the data output buffer 318 is stored in the memory 206 and is accessible and executable by the processor 204. In either embodiment, the data output buffer 318 is adapted for cooperation and communication with the processor 204 and other components of the computing device 200 including other components of the data reduction unit 210.

In one embodiment, the compression hash table module 312 and/or reference has table module 314 receives an encoded (e.g. compressed/reduced) data stream from the encoding engine 310. In some embodiments, the encoding engine 310 may transmit the encoded data stream to the data output buffer 318 for temporary storage. The encoded data stream may include, but is not limited to, one or more reference data blocks, reference data set(s) and/or current data blocks. Furthermore, storing an encoded data stream in the data output buffer 318 delivers the system exchange stability between receiving the encoded data stream and further processing of the encoded data stream. In some embodiments, the data output buffer 318 can be a queue plan for further processing of the one or more reference data blocks, reference data set(s) and/or data block(s) in by one or more components of the computing device 200.

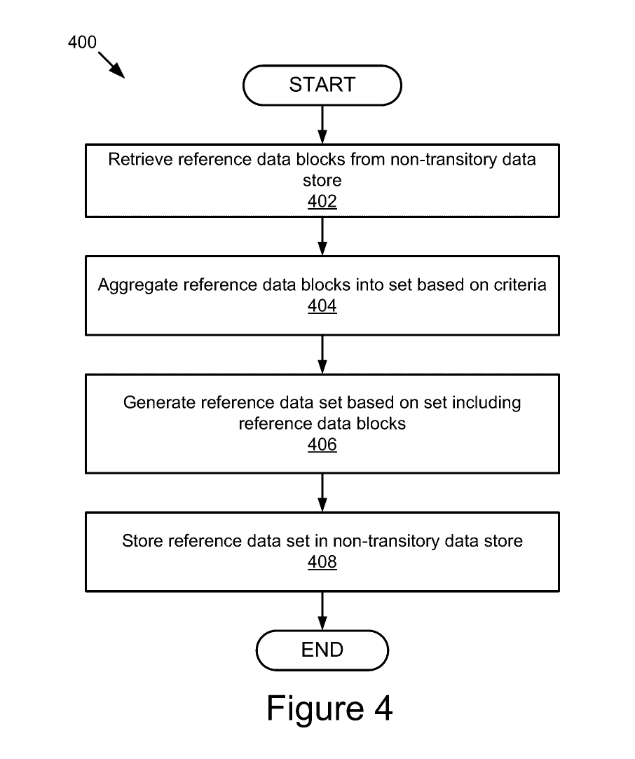

FIG. 4 is a flow chart of an example method 400 for generating a reference data set. The method 400 may begin by retrieving 402 reference data blocks from a non-transitory data store. In some embodiments, the data receiving module 208 receives the reference data blocks from a non-transitory data (e.g. flash memory, data storage repository 110/220).

Next, the method 400 may continue by aggregating 404 reference data blocks into a set based on a criterion. In some embodiments, the data reduction unit 210 may receive the reference data blocks from the data receiving module 208 and perform its functions therefrom. A criterion may include, but is not limited to, a degree of similarity between the reference data blocks. For example, reference data blocks can be associated with a file, wherein the file is divided into content-defined chunks and each reference block of the reference data blocks is associated with a content-defined chunk. In one embodiment, the reference data blocks share a degree of similarity based on the content-defined chunks of the file between corresponding reference data blocks.

In one embodiment, the degree of similarity can be associated with an identifier such as, but not limited to, resemblance hashes (e.g. digital signatures, and/or fingerprints) generated and assigned to each reference data block. A resemblance hash may include a hash value that can be a small number generated from a longer string of data. The hash value can be significantly smaller in data size than the reference data block. In some embodiments, the resemblance hashes are generated by an algorithm in such a way that it is unlikely for two reference data blocks to have an exact matching hash value. Also, identifiers associated with reference data blocks can be stored in a table of a database, for example, in data storage repository 110.

In further embodiments, the signature fingerprint computation engine 306 in cooperation with the matching engine 308 may aggregate one or more reference data blocks based on the criterion by querying a data store and comparing resemblance hashes associated with each of the reference data blocks to determine if a copy of the corresponding resemblance hashes already exists in the data store. In some embodiments, the matching engine 308 may aggregate one or more reference data blocks that share a similar matching resemblance hash. For example, two reference data blocks (e.g. reference data block A and reference data block B) can be associated with a document, however, reference data block A reflects an earlier version of the document while; reference data block B reflects a latter version of the document with modifications. Therefore, since reference data block A and reference data block B share a degree of similarity of the content associated with the document, reference data block A and reference data block B can be aggregated into a set. In some embodiments, the operations in step 404 can be performed by the signature fingerprint computation engine 306 and matching engine 308 in cooperation with one or more other entities of the system 100, as discussed elsewhere herein.

Next, the method 400 may advance by generating 406 a reference data set based on a set. A set may include, but is not limited to, reference data blocks sharing a degree of similarity between resemblance hashes of one or more reference data blocks. In one embodiment, the encoding engine 310 may receive the aggregated reference data blocks and generate a reference data set based on the aggregated reference data blocks. The reference data blocks of the reference data set serve as a model for future incoming data blocks by encoding the future incoming data blocks using the model comprising the reference data set. This model-based approach may lead to reduction in total volume being stored in for example, storage devices 112a through 112n of data storage repository 110. In some embodiments, the operations in step 406 can be performed by the signature fingerprint computation engine 306 and matching engine 308 in cooperation with one or more other entities of the system 100, as discussed elsewhere herein.

The method 400 may then continue by storing 408 the reference data set in a non-transitory data store (e.g. flash memory, data storage repository 110/220). In some embodiments, the above discussed can be applied in relation to data block of an incoming data stream, and as will be further discussed below. In some embodiments, the operations in step 408 can be performed by the encoding engine 310 in cooperation with the data output buffer 318 and/or one or more other entities of the system 100, as discussed elsewhere herein.

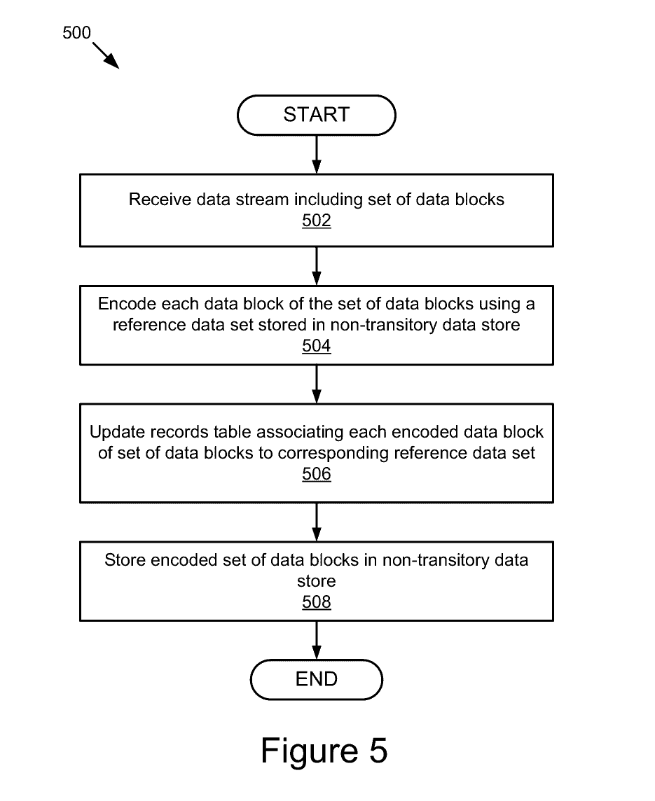

FIG. 5 is a flow chart of an example method 500 for aggregating data blocks into a reference data set. The method 500 may begin by receiving 502 a data stream including a set of data blocks. In some embodiments, the data receiving module 208 receives a data stream from client device 106 and transmits the data stream to the data input buffer 304 to perform operations therefrom. The data stream including the set of data blocks may be associated with, but is not limited to, a document, e-mails, applications (e.g. media applications, gaming applications, document editing applications, etc.) executed and rendered by client device 102, etc. For instance, the data stream can be associated with a file, wherein the data blocks of the data stream are content-defined chunks of the file. In some embodiments, the operation performed in step 502 may be performed by the data receiving module 208 in cooperation with one or more other entities of the system 100.

Next, the method 500 continues by encoding 504 each data block of the set of data blocks. In some embodiments, the encoding engine 310 in cooperation with the signature fingerprint computation engine 306 and/or matching engine 308 encodes each data block of the set of data blocks using a reference data set stored in a non-transitory data store, such as, but not limited to, data storage repository 110. Further, encoding of each data block of the set of data blocks may include an encoding algorithm. A non-limiting example of an encoding algorithm, may include, a proprietary encoding algorithm implementing deduplication/compression.

For example, the encoding engine 310 may utilize the encoding algorithm to identify similarities between each data block of the set of data blocks associated with the data stream and the reference data set stored in a data store (e.g. data storage repository 110). The similarities may include, but is not limited to, a degree of similarity between data content (e.g. content-defined chunks of each data block) and/or identifier information associated with each data block of the set of the data blocks and data content and/or identifier information associated with the reference data set.

In some embodiments, the signature fingerprint computation engine 306 and/or matching engine 308 can user a similarity-based algorithm to detect resemblance hashes (e.g. sketches) which have the property that similar data blocks and reference data sets have similar resemblance hashes (e.g. sketches). Therefore, if the set of data blocks are similar based on corresponding resemblance hashes (e.g. sketches) to an existing reference data set stored in storage, it can be encoded relative to the existing reference data set. The encoding engine 310 may then transmit the encoded data blocks of the set of data blocks to the compressed buffer 316 and/or the data output buffer 318. In some embodiments, the operation performed in step 504 may be performed by the encoding engine 310 in cooperation with one or more other entities of the data reduction unit 210 and/or system 100.

The method may then continue by updating 506 a records table associating each encoded data block of the set of data blocks to a corresponding reference data set. In one embodiment, the encoding engine 310 may transmit the encoded data blocks of the set of data blocks to the compression hash table module 312 and/or the reference hash table module 314 to perform operations therefrom. The compression hash table module 312 and/or the reference hash table module 314 may update a records table stored in data storage repository 110, wherein the records table associates each encoded data block to a corresponding reference data set stored in storage (i.e. data storage repository 110).

In one embodiment, the compression hash table module 312 may generate a reference data pointer for the encoded data block. The reference data pointer associated with the encoded data block may reference to a corresponding reference data set stored in data store that was used to encode the data block. In some embodiments, a reference data pointer may link to a corresponding identifier of a reference data set stored in a records table in a data store. In further embodiments, one or more encoded data blocks may share a same reference data pointer that references to a corresponding reference data set used to encode the one or more encoded data blocks of the set of data blocks. The operation performed in step 506 may be performed by the encoding engine 310 and/or the compression hash table module 312 and/or the reference hash table module 314 in cooperation with one or more other entities of the data reduction unit 210 and/or system 100.

The method 500 may then continue by storing 508 the encoded set of data blocks in a non-transitory data store (e.g. flash memory, data storage repository 110/220). The stored encoded set of data blocks, in some embodiments, can be a reduced version (e.g. smaller in data size) of the reference data set used to encode the data blocks of the set. For instance, a reduced version of a data block may include a header (e.g. reference pointer) and compressed/deduped data content associated with the data block. In some embodiments, the operations in step 508 may be performed by the encoding engine 310 in cooperation with the data output buffer 318 and/or one or more other entities of the system 100, as discussed elsewhere herein.

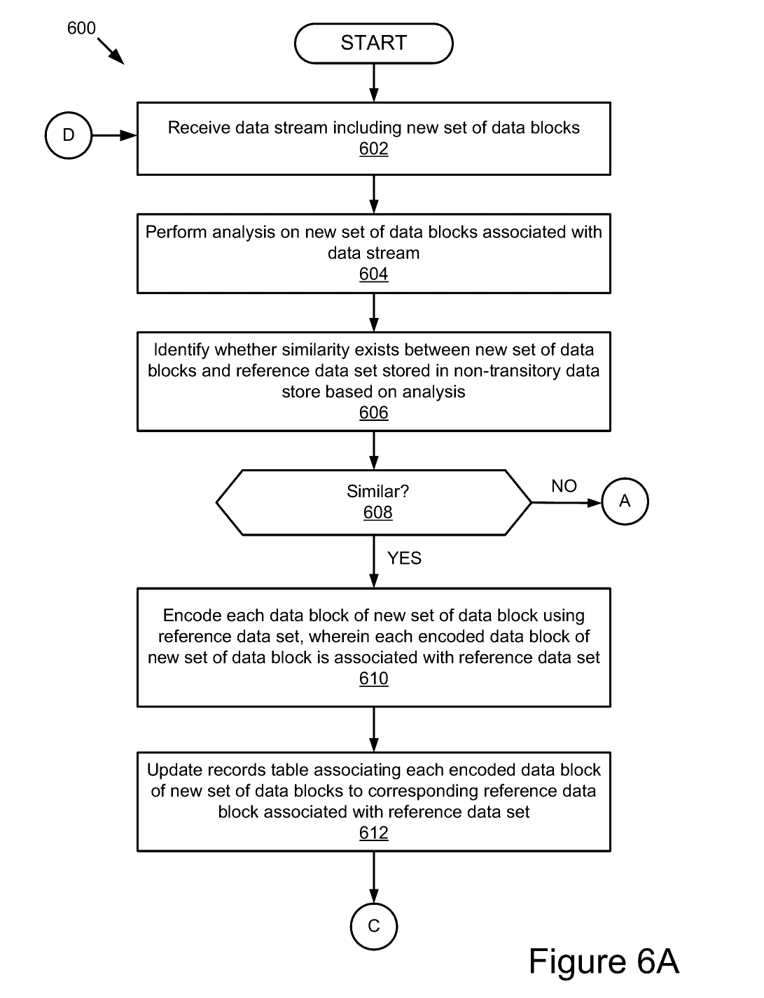

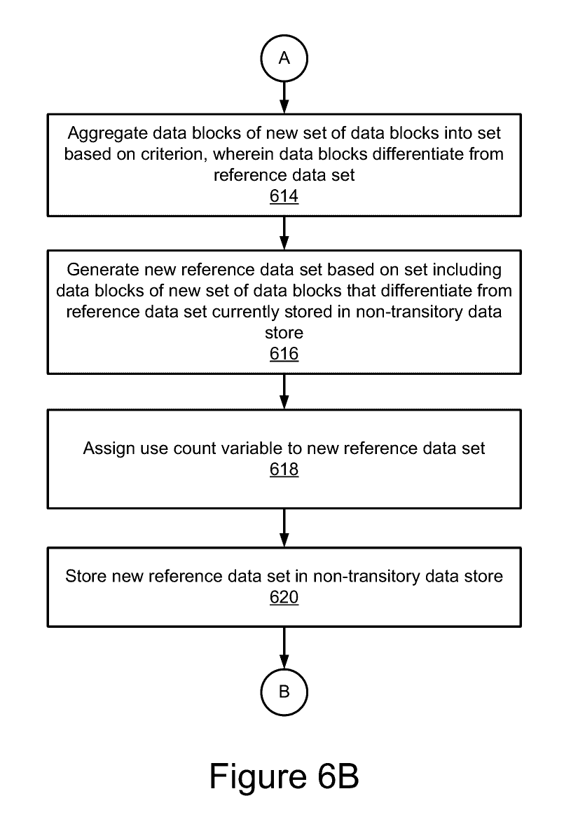

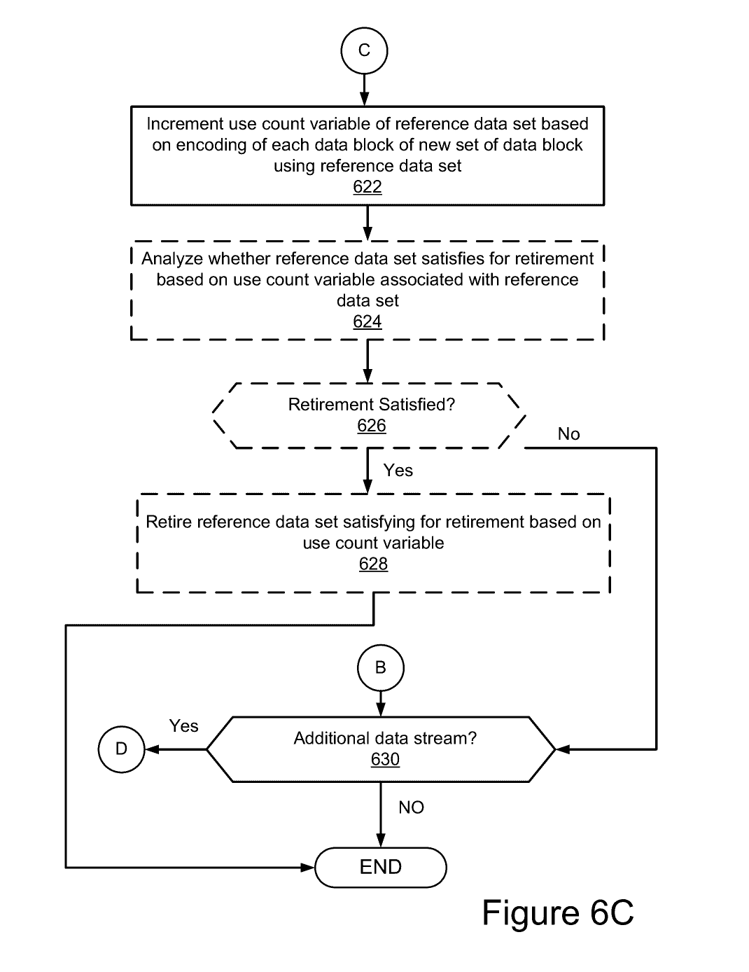

FIGS. 6A-6C are flow charts of an example method for aggregating reference blocks into a reference data set as a data stream changes. Referring now to FIG. 6A, the method 600 may begin by receiving 602 a data stream including a new set of data blocks. A new set of data blocks may include, but is not limited to, content data such as a document, an e-mail attachment, and information associated with applications executed and rendered by client devices (client devices 102). In one embodiment, the new set of data blocks is indicative of data that has not been previously stored and/or associated with a current reference data set stored in the data storage repository 110 and/or 220. In some embodiments, the operation performed in step 602 may be performed by the data receiving module 208 in cooperation with the data input buffer 304 and/or one or more other entities of the data reduction unit 210.

Next, the method 600 may advance by performing 604 an analysis on the new set of data blocks associated with the data stream. In some embodiments, the analysis can be performed by the signature fingerprint computation engine 306. For instance, the data receiving module 208 may transmit the new set of data blocks to the signature fingerprint computation engine 306. The signature fingerprint computation engine 306 may perform an analysis on content of the new set of data blocks responsive to receiving the data stream. Moreover, the analysis may include one or more algorithms for determining content reflecting in abstract content of the new set of data blocks and/or generating identifiers (e.g. fingerprints, hash values) for each data block of the new set of data blocks. A non-limiting example of an algorithm that determines content of new sets of data blocks may include, but is not limited to, an algorithm that uses collections of blocks that have at least an overlap among corresponding fingerprints. In another embodiment, an algorithm that determines content of new sets of data blocks may include, statistically clustering fingerprints of incoming data blocks and identifying one representative data block from each cluster.

In further embodiments, the fingerprint computation engine 306 may assign a general identifier (e.g. general fingerprint or general digital signature) to the new set of data blocks. A general identifier can be associated with a hash value that can be generated using a hash algorithm. The fingerprint computation engine 306 detects duplicated data part of the set of new data blocks, aggregates the duplicate data and assigns a general identifier in association to a hash value to the aggregated duplicate data. In some embodiments, the hash value can be a digital fingerprint or digital signature that identifies exclusively each data block of the new set of data blocks and/or identifies the set (i.e. the new set of data blocks) exclusively. In further embodiments, identifiers associated with a data stream including the new set of data blocks can be stored in a table of a database, for example, in data storage repository 110.

Furthermore, resemblance hashes can be used by the fingerprint computation engine 306 in cooperation with the matching engine 308 for analyzing the new set of data blocks for redundancy. In one embodiment, two or more data blocks are determined to be similar if resemblance hashes associated with the two or more data blocks satisfy a predetermined range (e.g. 0 to 1). For instance, a resemblance hash can be a number between 0 and 1, such that when the resemblance is close to 1 it is likely that content between two or more data blocks is roughly the same. In further embodiments, a resemblance hash can be a small sketch of a data block associated with the new set of data blocks. Further, an analysis of the new set of data blocks may include a similarity-based matching algorithm performed by the fingerprint computation engine 306 and/or matching engine 308 that includes parsing data storage repository 110. Parsing the data storage repository 110 may include comparing resemblance hashes of the new set of data blocks to resemblance hashes associated with one or more reference data sets stored in the data storage repository 110. In some embodiments, the operations in step 604 may be performed by the signature fingerprint computation engine 306 in cooperation with one or more other entities of the data reduction unit 210.

The method 600 may then continue by identifying 606 whether similarity exists between the new set of data blocks and at least one or more reference data sets. In some embodiments, the matching engine 308 in cooperation with the signature fingerprint computation engine 306 may identify whether a similarity exists between the new set of data blocks and one or more reference data sets stored in a non-transitory data store based on the analysis. For instance, the matching engine 308 may compare resemblance hashes of one or more reference data sets and/or segments of reference data sets stored in a data store such as, data storage repository 110, to resemblance hashes associated with the new set of data blocks. In some embodiments, the operations in step 606 may be performed by the matching engine 308 in cooperation with one or more other entities of the data reduction unit 210. The method 600 may then advance to 608 and determine whether similarity exists based on operations performed in 606.

If a similarity exits, the method 600 may advance to 610. For instance, the matching engine 308 may determine that resemblance hashes of the new set of data blocks share a degree of similarity with one or more reference data sets stored in a data store (e.g. data storage repository 110). Next, the method 600 may encode 610 each data block of the new set of data blocks using a corresponding reference data set stored in a data store (e.g. flash memory, data storage repository 110/220) based on the resemblance hash.

For instance, the encoding engine 310 in cooperation with one or more other components of 106 may determine that a data block of the new set has similarity resemblance to a stored data block of a reference data set in storage based on the resemblance hashes. The resemblance hash may represent a sketch of the data block and a sketch of the reference data block, and based on a degree of similarity between the sketches it can be determined whether the data block of the new data set and a reference data block in storage are similar in content. In one embodiment, the matching engine 308 transmits information indicating similar matches between resemblance hashes of the new set of data blocks and resemblance hashes of one or more reference data sets to the encoding engine 310.

The encoding engine 310 may encode 610 each data block of the new set of data blocks based on the information received from the matching engine 308. In some embodiments, the new set of data blocks can be segmented into chunks of data blocks in which the chunks of data blocks may be encoded exclusively. In one embodiment, the encoding engine 310 may encode each data block of the new set of data blocks using an encoding algorithm (e.g. deduplication/compression algorithm). An encoding algorithm may include, but is not limited to, delta encoding, resemblance encoding, and delta-self compression.

Moreover, encoding a data block that shares a degree of similarity with a reference data set may include the encoding engine 310, generating and assigning a pointer for each corresponding data block of the new set of data blocks. The pointer can be used by the storage-controlling engine 108 to reference and/or retrieve a corresponding data block and/or set of data blocks from storage (e.g. data storage repository 110/220) in the future for regeneration of the data blocks. In one embodiment, one or more data blocks may share a same pointer. For instance, one or more data blocks of the new set of data blocks may reference to a same reference data set stored in data storage repository 110/220, instead of storing the one or more data blocks independently in the data storage repository 110/220, the encoding engine 308 stores a compressed version of the one or more data blocks that includes a pointer (e.g. reference data pointer) that references to the same reference data set. In another embodiment, if the new set of data blocks are similar to an existing reference data set, the encoding engine 310 may store a delta showing the difference between the reference data set from which the new set of data blocks are encoded. The operations in step 610 may be performed by the encoding engine 306 in cooperation with a compressed buffer 316 and one or more other entities of the data reduction unit 210.

The method 600 may then advance by updating 612 a records table associating each encoded data block of the new set of data blocks to a corresponding reference data block associated with a reference data set. In one embodiment, the compression hash table module 312 receives the encoded data blocks and updates one or more pointers of each encoded data block in a records table stored in a data store (e.g. data storage repository 110/220). In other embodiments, the compression hash table module 312 receives an encoded set of data blocks and updates a pointer associated with the encoded set of data blocks in the records table stored in a data store (e.g. data storage repository 110/220). Pointer(s) associated with one or more encoded data blocks may be used latter to reference and/or retrieve a corresponding reference data block and/or reference data set from storage (e.g. data storage repository 110/220) and used for reconstructing each data block and/or set of data blocks associated with the received data stream.

Next, the method 600 continues from block 612 of FIG. 6A to block 622 of FIG. 6C by incrementing 622 a use count variable of a reference data set based on the encoding of each data block of the new set of data blocks using the reference data set. In one embodiment, the reference hash table module 314 receives from the encoding engine 310 an indicator that one or more reference data sets have been used to encode one or more data blocks and/or sets of data blocks associated with a data stream including the new set of data blocks. The reference hash table module 314 may then record each data block and/or set of data blocks to a corresponding reference data set and increment a use count variable of the corresponding reference data set. The use count variable may be indicative of a number of data blocks and/or set of data blocks that reference (e.g. point to the reference data set in storage using the pointer) a particular reference data set in storage. In some embodiments, the operations in step 622 may be performed by the encoding engine 306 in cooperation with the reference hash table module 314, update module 218, and/or one or more other entities of the data reduction unit 210.

The method 600 may advance by analyzing 624 whether a reference data set satisfies for retirement based on a use count variable associated with the reference data set. In one embodiment, the reference hash table module 314 may determine that a reference data set has not been referenced by one or more data blocks and/or sets of data blocks for a predetermined duration. Thus, if a reference data block of a reference data set is no longer being recalled for regeneration of a data block during a predetermined duration, a use count variable associated with the reference data set is modified (i.e. decremented). The predetermined duration may include a threshold assigned by default and/or administrator defined. In one embodiment, the reference hash table module 314 applies a use-count-retirement algorithm (e.g. garbage collection algorithm) to each reference data set stored in storage. The use-count-retirement algorithm may automatically decrement and/or increment a count of a use count variable associated with a reference data set after a predetermined duration is satisfied, and the reference data set has not been referenced by one or more data blocks or sets of data blocks associated with a data stream during the predetermined duration. In other embodiments, the use-count-retirement algorithm may increment a count associated with the use count variable of a reference data set responsive to the reference data set being associated with a data recall. A data recall may indicate a request by a client device 102 for rendering a document that may require one or more data blocks to be reconstructed. The operations in step 624 may be optional and performed by the reference hash table module 314 in cooperation with the encoding engine 306 and one or more other entities of the data reduction unit 210.

The method 600 may then advance to 626 and determine whether retirement for a corresponding reference data set is satisfied. If a reference data set satisfies for retirement, the method 600 may advance by retiring 628 the reference data set satisfying for retirement based on the use count variable. In one embodiment, the reference hash table module 314 determines that reference data set satisfies for retirement based on the use count variable decrementing to a particular threshold value. In some embodiments, a reference data set may satisfy for retirement when a count of the use count variable of the reference data set decrements to zero. A use count variable of zero may indicate that no data blocks or sets of data blocks rely and/or reference to that corresponding reference data set. For example, no data blocks (e.g. compressed/deduped data blocks) rely on a reference data set for reconstructing an original version of the data block. The operations in step 628 may be optional and performed by the reference hash table module 314 in cooperation with the data retirement module 216 and one or more other entities of the data reduction unit 210. The method 600 may then end.

However, if no reference data sets satisfy for retirement in block 626 the method 600 may advance to determine 630 whether an additional incoming data stream is present. If there is an additional incoming data stream, the method 600 may return to step 602 of FIG. 6A, otherwise the method 600 may end.

Referring back to step 608 of FIG. 6A, if no similarity exits, the method 600 may advance to block 614 of FIG. 6B by aggregating data blocks of the new set of data blocks into a set based on criterion, and wherein the data blocks differentiate from the reference data sets stored currently in storage (e.g. data storage repository 110). Data blocks differentiating from the reference data sets stored currently in storage may include data blocks associated with content that varies from content associated with the reference data sets stored in storage. A criterion may include, but is not limited to, content associated with each data block, administrator defined rules, data size consideration for data blocks and/or sets of data blocks, random selection of hashes associated with each data block, etc. For instance, a set of data blocks may be aggregated together based on the data size of each corresponding data block being within predefined range. In some embodiments, one or more data blocks may be aggregated based on a random selection. In further embodiments, a plurality of criteria may be used for aggregation. The operations in step 614 may be performed by the matching engine 308 in cooperation with the data clustering module 214 and one or more other entities of the computing device 200.

Next, the method 600 may continue by generating 616 a new reference data set based on the set including data blocks of the new set of data blocks that differentiate from the reference data set currently stored in a non-transitory data store (e.g. data storage repository 110/220). In one embodiment, the matching engine 308 transmits the set to the encoding engine 310, and the encoding engine 310 then generates a new reference data set that may include one or more data blocks that satisfy a criterion. For instance, the new reference data set can be generated based on one or more data blocks satisfying a data size being within an assigned predefined range. In one embodiment, the encoding engine 310 generates the new reference data set based on the one or more data blocks sharing content that is within a degree of similarity between each of the one or more data blocks. In some embodiments, responsive to generating the new reference data set, the signature fingerprint computation engine 306 may generate an identifier (e.g. fingerprint, hash value, etc.) for the new reference data set. The operations in step 616 can be performed by the matching engine 308 in cooperation with the data-clustering module 214 and one or more other entities of the computing device 200.

The method 600 may then advance by assigning 618 a use count variable to the new reference data set. In one embodiment, the encoding engine 310 assigns a use count variable to the new reference data set. The use count variable of the new reference data set may indicate a data recall number associated with a number of times data blocks or sets of data blocks reference the new reference data set. In further embodiments, the use count variable may be part of the hash and/or a header associated with the reference data set. The new reference data set may satisfy for retirement when a count of the use count variable of the new reference data set decrements to a particular value (e.g. zero). In some embodiments, an initial count may be assigned to the use count variable by an administrator. The operations in step 618 may be performed by the reference hash table module 314 in cooperation with the data retirement module 216 and one or more other entities of the data reduction unit 210.

Next, the method 600 may then store 620 the new reference data set in a non-transitory data store. For instance, the encoding engine 310 may generate the new reference data set and store it in data storage repository 110 and/or 220. The method 600 may then advance to block 630 of FIG. 6C and determine whether an additional incoming data stream is present. If there is an additional incoming data stream the method 600 may return to step 602 of FIG. 6A, otherwise the method 600 may end.

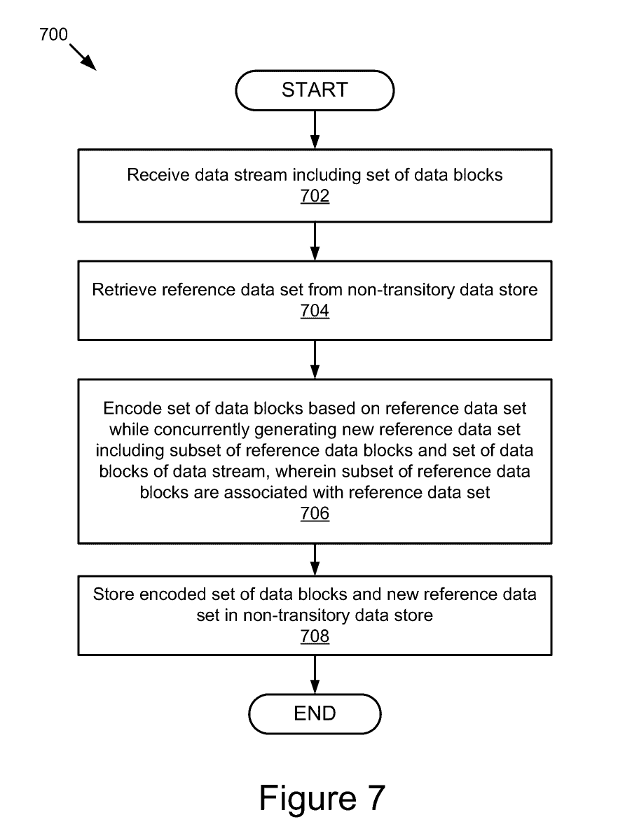

FIG. 7 is a flow chart of an example method 700 for encoding data blocks in a pipelined architecture. The method 700 may initiate by receiving 702 a data stream including a set of data blocks. For instance, the data-receiving module 208 receives the data stream including the set of data blocks from a client device (e.g. client device 102). In some embodiments, the data stream may be associated with, but not limited to, content data such as a document files and e-mail attachments executed and rendered by client devices. In further embodiments, the operations in step 702 may be performed by the data receiving module 208 in cooperation with the data input buffer 304 and one or more other entities of the system 100, as discussed elsewhere herein.

Next, the method 700 may continue by retrieving 704 a reference data set from a non-transitory data store.

In one embodiment, the matching engine 308 retrieves a reference data set responsive to performing an analysis on the data stream. For example, the signature fingerprint computation engine 306 may perform an analysis on content of the data stream including content of each of the data blocks of the set and/or content mutually associated with the set of data blocks. In one embodiment, the analysis may include a hash values and/or fingerprint matching algorithm performed by the fingerprint computation engine 306 that includes comparing hash values and/or fingerprint associated with the data stream including the set of data blocks to hash values and/or fingerprint associated with one or more reference data sets stored in the data storage repository 110. In some embodiments, the matching engine 308 identifies similarity between the data stream and reference data sets previously stored in storage by comparing resemblance hashes (e.g. sketches) associated with the data stream and the reference data set previously stored in storage. In further embodiments, the operations in step 704 may be performed by the signature fingerprint computation engine 306 in cooperation with the matching engine 308 and one or more other entities of the data reduction unit 210.

The method 700 may advance by encoding 706 the set of data blocks based on the reference data set. Encoding may include, but is not limited to, modifying data by performing one or more of deduplication, compression, etc., on the data. In some embodiments, the encoding engine 310 encodes the set of data blocks based on the reference data set while, concurrently generating a new reference data set including a subset of reference data blocks and a set of data blocks associated with the data stream. In one embodiment, the subset of reference data blocks can be associated with a corresponding reference data set. For instance, prior to encoding the set of data blocks, the encoding engine 310 may analyze one or more reference data sets stored in data storage 110/220.

In some embodiments, an analysis of the reference data sets may be based on one or more predefined conditions. For instance, a predefined condition may include identifying popular reference data blocks inside the reference data set that are data recalled (above a threshold value) by at least one entity of the system 100 for reconstructing an original data block (i.e. a data block or set of data blocks reversed to an original state prior to being encoded) more than a threshold number of times (e.g. per min, per hours, per day, per week, per month, per year). In some embodiments, the popular reference data blocks can be flagged or assigned an identifier indicating a relative importance. An identifier may include, but is not limited to, a pointer, header of associated with a data block that includes information associated with the data block. Further, the relative importance can be indicative that a corresponding reference data block associated with a reference data set is utilized above a threshold for reconstructing data blocks compared to neighboring reference data blocks that are part of the same reference data set.

The method 700 may then continue by encoding 706 a set of data blocks using a reference data set stored in a non-transitory data store. The set of data blocks that are encoded using the reference data set share a degree of similarity between content associated with the set of data blocks and the reference data set. In one embodiment, the encoding engine 310 encodes a new set of data blocks based on a reference data set while concurrently generating a second reference data set including the one or more popular reference data blocks and a subset of new data blocks of the data stream. In further embodiments, the subset of reference data blocks comprise a predetermined amount of data blocks. In other embodiments, encoding of the new set of data blocks is based on a degree of similarity between the new set of data blocks and the reference data set.

Further, the encoding engine 310 may, while encoding the set of data blocks sharing the degree of similarity with one or more reference data sets stored in the non-transitory data store, concurrently generate a new reference data set that includes: 1) encoded data blocks that do not share a degree of similarity with one or more reference data sets currently stored in storage; and 2) popular reference data blocks associated with one or more reference data sets stored in storage. Thus, the new reference data set comprises both 1) data blocks that do not share a degree of similarity with one or more reference data sets currently stored and 2) popular reference data blocks associated with one or more reference data sets stored in storage. This functions to support the system 100 in actively constructing new reference data sets for changing data streams since the reference blocks represent the data stream in abstract. Since the reference data blocks represent the data stream in abstract, as the nature of the data stream changes, the set of reference blocks also changes over time, it is expected that some blocks cease to be members of the reference set, while new blocks are added, leading to a new reference set. Therefore, an important metric for determining whether the reference set is a good representation of the incoming data stream, it is important to manage the reference set actively. Otherwise, the system may include stale data stored in storage, and have less capacity to store incoming relevant data. In some embodiments, the operations in step 706 may be performed by the signature fingerprint computation engine 306 in cooperation with the matching engine 308, the encoding engine 310, and one or more other entities of the data reduction unit 210.

Next, the method 700 may store 708 the set of data blocks and the new reference data set in a non-transitory data store.

In one embodiment, the compression hash table module 312 and the reference hash table module 314 may update and/or store corresponding identifiers associated with the set of data blocks and the new reference data set in a table for referencing and retrieving the set of data blocks and/or the new reference data set. In some embodiments, the encoding engine 310 in cooperation with the compressed buffer 316 and the data output buffer 318 stores the set of data blocks and the new reference data set in data storage repository 110/220.

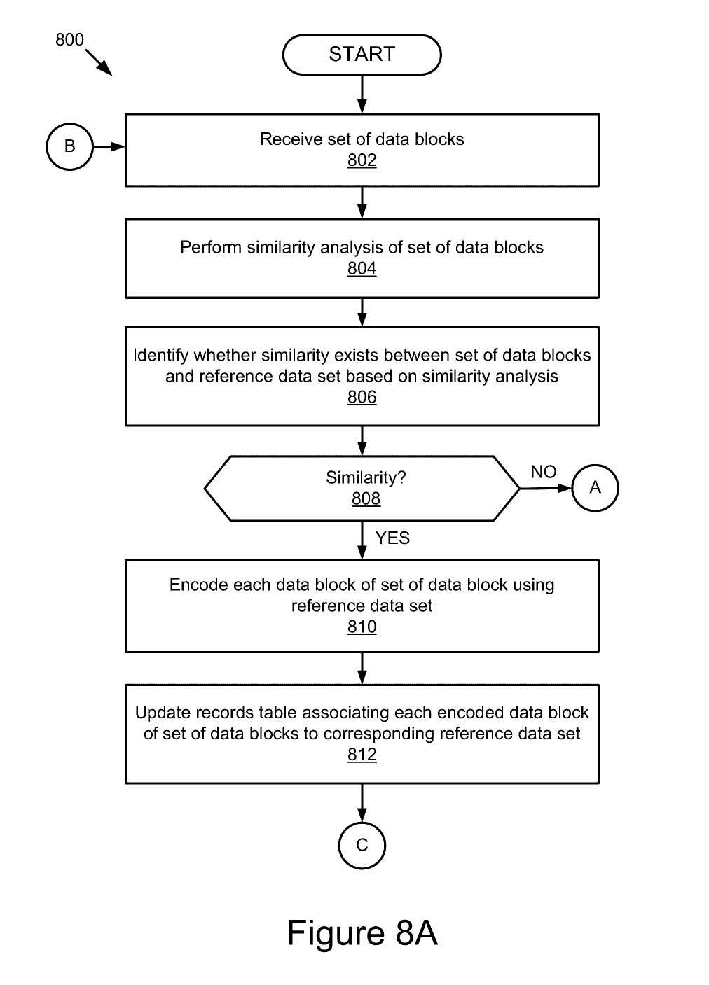

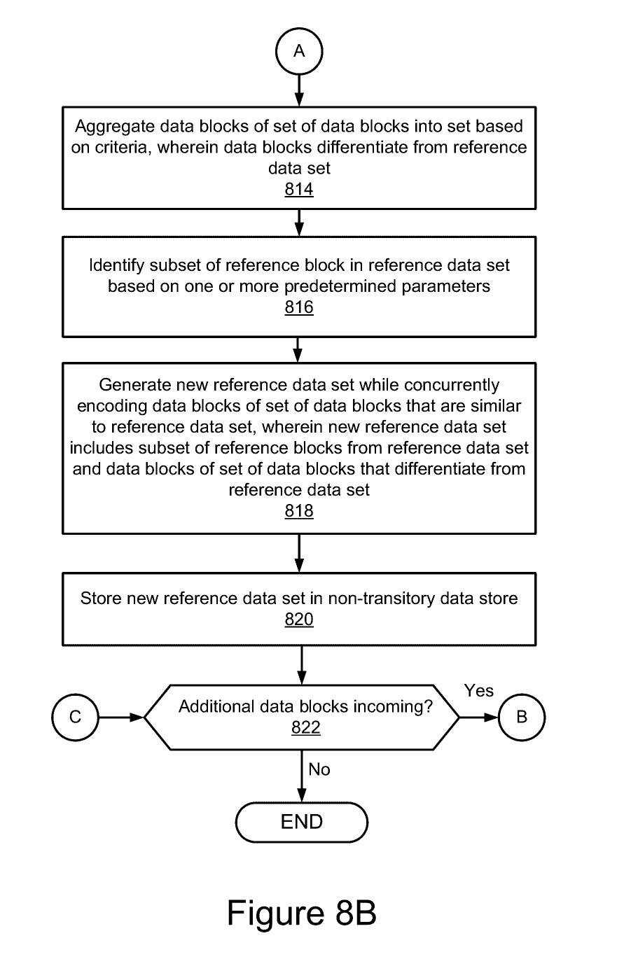

FIGS. 8A and 8B are flow charts of an example method for generating a reference data set in a pipelined architecture. Referring now to FIG. 8A, the method 800 may begin by receiving 802 a set of data blocks. In one embodiment, the data-receiving module 208 in cooperation with data input buffer 304 receives a set of data blocks from one or more client devices (e.g. client devices 102). The set of data blocks can be associated with, but not limited to, document files of a type such as, but not limited to, word doc, pdfs, jpegs, etc., rendered by applications of the client devices (e.g. client devices 102). Next, the method 800 may continue by performing 804 a similarity analysis of the set of data blocks. In some embodiments, the analysis may be performed by the signature fingerprint computation engine 306. For instance, the data-receiving module 208 may transmit the set of data blocks to the signature fingerprint computation engine 306 to perform its respective functionalities. The signature fingerprint computation engine 306 may perform an analysis on content of the set of data blocks. The analysis may include, one or more algorithms for determining content associated with the set of data blocks. In some embodiments, the fingerprint computation engine 306 may generate identifiers for each data block of the set of data blocks based on the content of each block.

In further embodiments, the fingerprint computation engine 306 may assign a general identifier for the set of data blocks. An identifier may be associated with a hash value that can be generated using a hash algorithm. In some embodiments, identifiers associated with a set of data blocks can be stored in a database, for example, in data storage repository 110. In other embodiments, the identifiers can be a digital fingerprint or digital signature that classifies exclusively each data block of the set of data blocks and/or classifies the set (i.e. the set of data blocks) exclusively. The identifiers can be used by the fingerprint computation engine 306 and/or the matching engine 308 for analyzing the set of data blocks for redundancy. For example, the analysis may include applying a matching-based algorithm by the fingerprint computation engine 306 that includes comparing identifiers of the set of data blocks to identifiers associated with one or more reference data sets stored in the data storage repository 110.

Next, the method 800 continues by identifying 806 whether similarity exists between the set of data blocks and at least one or more reference data sets. In some embodiments, the matching engine 308 in cooperation with the signature fingerprint computation engine 306 may identify whether a similarity exists between the set of data blocks and one or more reference data sets stored in a non-transitory data store based on the analysis. For instance, the matching engine 308 may responsive to receiving data from the fingerprint computation engine 306 that no exact matches were identified between the set of data blocks and reference data sets stored in storage, generate resemblance hashes for the set of data blocks. The matching engine 308 can then compare resemblance hashes of one or more reference data sets stored in a data store such as, data storage repository 110 to resemblance hashes associated with the set of data blocks. In one embodiment, the matching engine 308 may compare resemblance hashes of one or more reference data sets stored in a data store such as, data storage repository 110 to individual resemblance hashes associated with each data block of the set of data blocks. In some embodiments, the operations in step 806 may be performed by the matching engine 308 in cooperation with one or more other entities of the data reduction unit 210.

The method 800 may then advance to 808 for determining whether similarity exists. For instance, the matching engine 308 may determine that content of the set of data blocks share a degree of similarity with one or more reference data sets stored in a data store based on an identifier (e.g. resemblance hash). A degree of similarity may include a threshold of similar content between a set of data blocks of an incoming data stream and that of reference data sets stored in storage. In one embodiment, a degree of similarity can be determined by comparing resemblance hashes (i.e. sketches) of data blocks to that of reference data sets. If a similarity exits, the method 800 may advance to block 810. Next, the method 800 may encode 810 each data block of the set of data blocks using a corresponding reference data set stored in a non-transitory data store. A corresponding reference data set can be a reference data set that shares a degree of similarity with one or more data blocks of an incoming data stream. For instance, data blocks of an incoming data set may include revised content of a document (i.e. current version of a document) that was previously stored in storage and associated by a reference data set. The incoming data set may preserve a degree of similarity with that of the reference data set (i.e. previously saved version of the document) based on satisfying a threshold (i.e. a sketch of the current version of the document ‘incoming data set’ is within resemblance of that of the previous version ‘reference data set’ sketch). The encoding engine 308 may use the reference data set if the threshold is satisfied to encode the incoming data set (i.e. compress dedupe) such that duplicate copies are not stored but, rather a compressed version is stored). In some embodiments, the set of data blocks includes segments/chunks of data blocks in which the segments/chunks of data blocks may be encoded exclusively with a reference data set.

The matching engine 308 may transmit information indicating similar matches between content of the set of data blocks and one or more reference data sets, to the encoding engine 310. The encoding engine 310 may then encode each data block of the set of data blocks based on the information received from the matching engine 308. In one embodiment, the encoding engine 310 may encode each data block of the set of data blocks using an encoding algorithm such as, but not limited to, delta encoding, resemblance encoding, and delta-self compression. In some embodiments, encoding a data block that shares a degree of similarity with a reference data set may include the encoding engine 310, generating and assigning a pointer for each corresponding data block of the set of data blocks. The pointer may be used by the storage-controlling engine 108 to reference and/or retrieve a corresponding reference data block and/or set of reference data blocks from storage (e.g. data storage repository 110/220) for future data recalls. In further embodiments, one or more data blocks of the set of data blocks may reference to a same reference data set stored in data storage repository 110/220, instead of storing the one or more data blocks independently in the data storage repository 110/220, the encoding engine 308 stores a compressed version of the one or more data blocks that includes a pointer (e.g. reference data pointer) that references a reference data set. The operations in step 810 may be performed by the encoding engine 306 in cooperation with a compressed buffer 316 and one or more other entities of the data reduction unit 210.

The method 800 may then advance by updating 812 a records table associating each encoded data block of the set of data blocks to a corresponding reference data set. In one embodiment, the compression hash table module 312 receives the encoded data blocks and updates one or more pointers of each encoded data block in the records table stored in a data store (e.g. data storage repository 110/220). In other embodiments, the compression hash table module 312 receives an encoded set of data blocks and updates a pointer associated with the encoded set of data blocks in the records table stored in a data store (e.g. data storage repository 110/220).

The method 800 may transition from block 812 of FIG. 8A to block 822 of FIG. 8B to determine 822 whether additional data blocks are incoming. If there is additional incoming data blocks the method 800 may return to step 802 (of FIG. 8A), otherwise the method 800 may end.

Referring back to step 808 of FIG. 8A, if no similarity exists, the method 800 may advance to block 814 of FIG. 8B by aggregating data blocks of the set of data blocks into a set based on a criterion, and wherein the data blocks differentiate from the reference data sets previously stored in storage (e.g. data storage repository 110/220). A criterion may include, but is not limited to, content associated with each data block, data size consideration for data blocks and/or sets of data blocks, random selection of hashes associated with each data block, etc. For instance, a set of data blocks may be aggregated together based on the data size of each corresponding data block being within predefined range. The operations in step 814 may be performed by the matching engine 308 in cooperation with the data-clustering module 214 and one or more other entities of the computing device 200.

Next, the method 800 may advance by identifying 816 a subset of reference data blocks associated with one or more reference data sets based on one or more predetermined parameters. In one embodiment, the encoding engine 310 may analyze and identify a subset of reference data blocks associated with one or more reference data sets stored in data storage 110/220. The analysis may include identifying reference data blocks of one or more reference data sets that are frequently data recalled (i.e. a parameter with data recalled threshold and/or threshold ranges) by one or more entities of system 100 for reconstructing an original data block (i.e. a data block or set of data blocks reversed to an original state prior to being encoded). In some embodiments, the reference blocks can be flagged or assigned an identifier indicating a relative importance. The relative importance can be indicative that a corresponding reference data block associated with a reference data set is utilized above a threshold for reconstructing data blocks compared to other neighboring reference data blocks that are part of the same reference data set. The encoding engine 310 may then aggregate the reference data blocks that are flagged or assigned an identifier indicating a relative importance into a subset of reference data blocks. In some embodiments, reference blocks are grouped into a subset based on a degree of similarity associated with content of each reference data block.

The method 800 may then generate 818 a new reference data set while concurrently encoding data blocks of the set of data blocks that share a degree of similarity with one or more reference data sets. In one embodiment, a new reference data set can be generated serially with data block of the set of data block that share a degree of similarity with one or more reference data sets. In some embodiments, the encoding engine 310 generates the new reference data set while contemporaneously encoding data blocks of the set of data blocks that share a degree of similarity with one or more reference data sets. The new reference data set may include the subset of reference data blocks from one or more reference data sets and data blocks of the set of data blocks that differentiate from reference data sets previously stored in non-transitory data store (e.g. data storage repository 110/220).

For instance, the encoding engine 310 may encode a set of data blocks using a reference data set, wherein the set of data blocks that are encoded using the reference data set share a degree of similar content with the reference data set. The encoding engine 310 while encoding the set of data blocks sharing the degree of similarity with one or more reference data sets may also, concurrently generate a new reference data set that includes, encoding data blocks that do not share a degree of similarity (i.e. differentiating content) with one or more reference data sets and a subset of reference data blocks associated with one or more reference data sets.

Thus, the new reference data set comprises both data blocks (i.e. comprise differentiating content from one or more reference data sets previously stored) and a subset of reference data blocks associated with one or more reference data sets stored in the non-transitory data store. In some embodiments, the operations in step 818 may be performed by the matching engine 308, the encoding engine 310, and/or one or more other entities of the data reduction unit 210.

The method 800 may then advance by storing 820 the new reference data set in a non-transitory data store. The non-transitory data store may include, but is not limited to, data storage repository 110/220 and/or individual storage devices 112. In one embodiment, the compression hash table module 312 receives the new reference data set and generates an identifier associated with the new reference data set. The identifier can be stored in a records table stored in a data store (e.g. data storage repository 110/220) and/or can be part of the reference data set. The identifier can be used to reference and/or retrieve the new reference data set from storage (e.g. data storage repository 110/220) and used for reconstructing incoming data blocks of a data stream. The method 800 may continue by determining 822 whether additional data blocks are incoming. If there is additional incoming data blocks the method 800 may return to step 802, otherwise the method 800 may end.

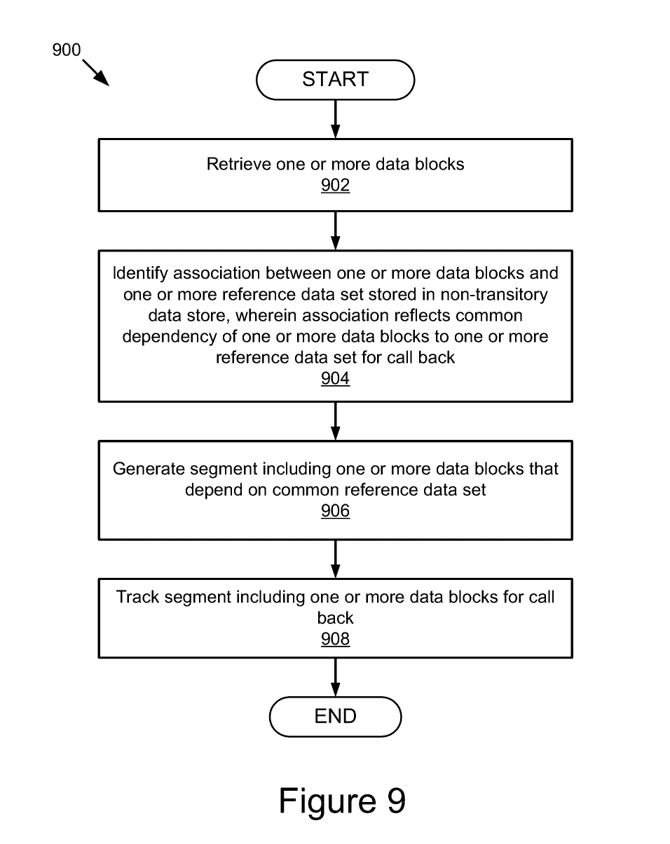

FIG. 9 is a flow chart of an example method 900 for tracking reference data sets in flash storage management. The method 900 may begin by retrieving 902 one or more data blocks. In one embodiment, the data-receiving module 208 may retrieve one or more data blocks from a non-transitory data store (i.e. data storage repository 110/220). The one or more data blocks may include, but is not limited to, content data such as documents, gaming associated application, e-mail attachments, and additional information associated with applications executed and rendered by client devices (e.g. client devices 102).

Next, the method 900 may continue by identifying 904 associations between one or more data blocks and one or more reference data sets stored in non-transitory data store (e.g. flash storage). In one embodiment, the signature fingerprint computation engine 306 in cooperation with the matching engine 308 may receive the one or more data blocks from the data receiving module 208, and identify associations between the one or more data blocks and one or more reference data sets stored in data storage repository 110/220 (e.g. a flash storage). An association of one or more data blocks to one or more reference data sets may reflect a common dependency of one or more data blocks to one or more reference data sets for data recall. For example, a data recall may include one or more data blocks of an incoming data stream referencing to one or more reference data sets for reconstructing and/or encoding.

The method 900 may continue by generating 906 one or more segments in a data store (e.g. data storage repository 110/220) including one or more data blocks that depend on a common reference data set. In one embodiment, the matching engine 308 identifies associations between data blocks and reference data sets stored in a data store (e.g. a flash storage, data storage repository 110/220) and generates segments in the data store (e.g. a flash storage, data storage repository 110/220) that includes one or more data blocks and one or more reference data sets that share an association. A segment refers to a collection/portion of flash storage that can be filled sequentially and erased as a unit. Each data block can be associated with the reference data set (and specific reference data blocks within them) can be relied on for recall.

In further embodiments, a segment in a non-transitory data store may include, but is not limited to, a predefine storage size for one or more data blocks that share an association with one or more reference data sets. In some embodiments, each segment has a segment header that includes information such as, an identifier including the number of times the segment has been erased, written, and/or read, a timestamp, and data-block information array. The data-block information array may include, but is not limited to, information about each data block associated with the segment and/or information exclusive to a set of data blocks. In some embodiments, a segment can be associated with a segment summary header. The segment summary header may include information such as, but not limited to, global information about the segment and total data blocks associated with the segment.

Next, the method 900 may continue by tracking 908 the reference data set associated with the segment for data recall. In one embodiment, the data-tracking module 212 may track segments in a non-transitory data for data recall by one or more client devices 102. For example, a client device 102 may be rendering one or more applications and request accesses to content associated with a segment including data blocks stored in non-transitory data store, the data tracking module 212 may then track the number of times a segment and/or reference data set is called back upon to render one or more contents associated with the request. Thus, instead of tracking use of a reference data set by each data block individually, the system 100 can track the use of a reference data block by a set of data blocks in a segment of memory in non-transitory flash data storage. In some embodiments, the data-tracking module 212 transmits information associated with the data recall to the update module 218 for updating a segment header associated with the reference data set of the segment associated with the data recall by the client device 102. In one embodiment, the update module 218 updates a portion of the segment header that include the number of times the segment has been data recalled. The operations in step 908 may be performed by the data tracking module 212 and the update module 218 and/or one or more other entities of the computing device 200.

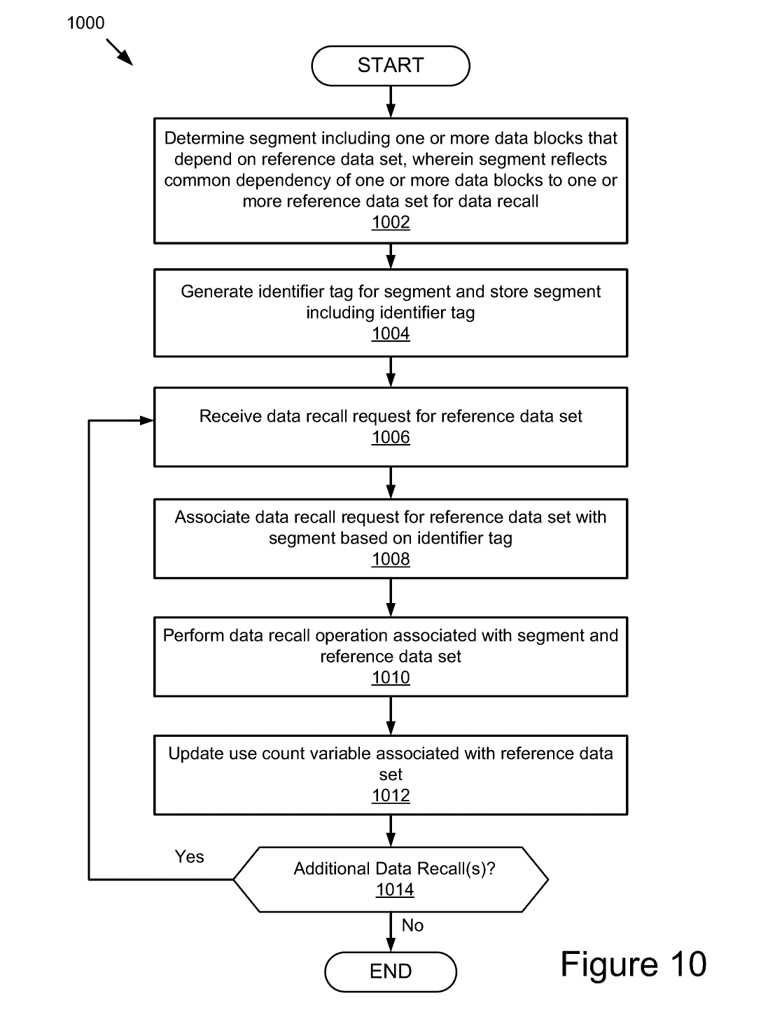

FIG. 10 is a flow chart of an example method 1000 for updating count variables associated with a reference data set. The method 1000 may begin by determining 1002 a segment including one or more reference data sets. In one embodiment, the data-clustering module 214 determines one or more data blocks that depend on a reference data set based on the one or more data blocks sharing a degree of similarity between content of the one or more data blocks and the reference data sets. In some embodiments, the data clustering module 214 in cooperation with the matching engine 308 determines dependency of one or more data blocks to one or more reference data sets stored in segments of a corresponding memory such as, a non-transitory flash data store (e.g. flash memory that can be one or more storage devices 112). A dependency of one or more data blocks to one or more reference data sets may reflect a common reconstruction/encoding dependency of one or more data blocks to one or more reference data sets of a segment in memory for future data recall.

Next, the method 1000 may continue by generating 1004 an identifier tag for a reference data set associated with a segment of memory in a non-transitory data store. In one embodiment, the data-tracking module 212 generates an identifier tag for the segment including one or more data blocks that depend on a reference data set stored in non-transitory data store (e.g. flash memory, storage devices 112, etc.) and stores the identifier tag in the non-transitory data store. For example, an identifier tag can be, but is not limited to, a segment header that includes information such as, the number of times the segment has been erased, written, and/or read, a timestamp, and data-block information array. The data-block information array may include, but is not limited to, information about each data block associated with the segment and/or information exclusive to a set of data blocks of the segment in the non-transitory data store (i.e. solid-state device, flash memory, etc.). In some embodiments, the operations in step 1004 can be performed by the data-tracking module 212 and/or data-clustering module 214 in cooperation with one or more other entities of the computing device 200.

The method 1000 may advance by receiving 1006 a data recall request for a reference data set. In one embodiment, the data-receiving module 208 receives a request for a reference data set that may be stored in a segment of the non-transitory data store. The data recall request can be associated with rendering one or more contents associated with applications executed on the client devices 102. Next, the method 1000 may continue by associating 1008 the data recall request for the reference data set with a segment based on the identifier tag. In one embodiment, the data-tracking module 212 can associate the data recall request from a client device to a reference data set of a segment stored in non-transitory flash data store using the identifier tag. The identifier tag can be associated with a segment header of the reference data set that includes identification information and additional data such as, the number of times the segment has been erased, written, and/or read.

The method 1000 may advance by performing 1010 a data recall operation associated with the segment and the reference data set. In one embodiment, the data reduction unit 210 may perform the data recall operation associated with the segment including the reference data set stored in non-transitory data store. The data recall operation may include, operation such as, but not limited to, reconstructing one or more data blocks and/or encoding one or more data blocks of an incoming data stream. Responsive to performing the data recall operation, the method 1000 may advance by updating 1012 a use count variable associated with the reference data set. For instance, the data-tracking module 212 can update the use count variable associated with a segment including the reference data set stored in a non-transitory data store.

In some embodiments, the use count variable can be part of the segment header associated with the segment of a non-transitory data store that includes the reference data set called on for data recall operations. As discussed throughout this present disclosure, the use count variable may be indicative of a number of data blocks and/or set of data blocks that reference (e.g. point to the reference data set in storage using a pointer) a particular reference data set associated with a segment of memory in storage (e.g. flash memory). In further embodiments, the use count variable associated with a reference data set can be stored independently in a records table in a data store such as, data storage repository 110.

Next, the method 1000 may continue by determining 1014 whether additional data recall(s) are in queue. If there are additional data recall(s) present in queue, the method 1000 can return to step 1006, otherwise the method 1000 can end.

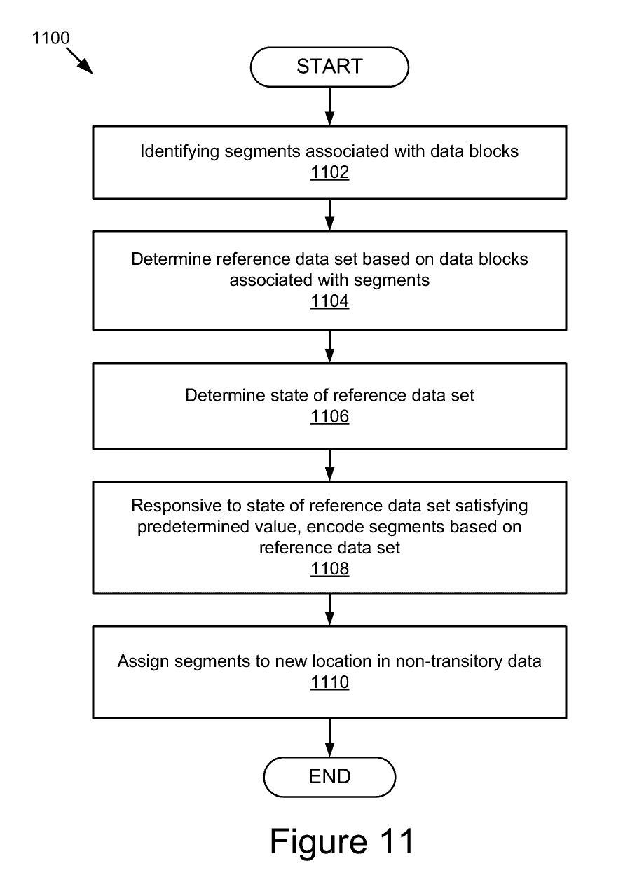

FIG. 11 is a flow chart of an example method 1100 for assigning encoded data segments to a new location in non-transitory data store (e.g. flash memory). The method 1100 may begin by identifying 1102 segments associated with data blocks. In one embodiment, the data-receiving module 208 identifies segments of memory of a non-transitory data store including one or more data blocks.

Next, the method 1100 advances by determining 1104 a reference data set based on the data blocks associated with the segments. In one embodiment, the data-tracking module 212 determines a reference data set associated with a segment of non-transitory data store based on an identifier (e.g. segment header) of the reference data set. Responsive to determining a reference data set, the method 1100 can continue by determining 1106 a state of the reference data set. In one embodiment, the data-tracking module 212 may determine a state of the reference data set based on a predetermined factor (e.g. segments of memory that include stale data, data due for deletion, etc.). For instance, the data tracking module 212 may identify, compare and redistribute one or more data blocks from partially filled segments based on the state of the reference data set, and delete invalid data blocks (i.e. stale data, data due for deletion) that are part of the reference data set such that a segment and/or data block of a reference data set can be reassigned. A non-limiting example of a predetermined factor may include a reference data set being on path for retirement.

Next, the method 1100 may advance by encoding 1108 the segments based on the reference data set. In one embodiment, the encoding engine 310 encodes the segments associated with the data blocks based on the reference data set.

Lastly, the method 1100 may continue by assigning 1108 the segments including the reference data set to a new location in the non-transitory flash data store. In one embodiment, the encoding engine 310 in cooperation with the output buffer 318 assign segments including the reference data sets that satisfy a predetermined value associated with the state, to a new location in the non-transitory data store (e.g. flash memory). For instance, four data blocks (A, B, C, D) that can reflect a reference data set are written to a segment of memory in a non-transitory data store. Next, four new data blocks (E, F,G, H) and four replacement data blocks (A′, B′, C′, D′) are written to the segment of memory (e.g. flash memory). The original four data blocks (A, B, C, D) are now invalid (e.g. do not satisfy a predetermined values associate with the state of the original reference data set) data, however, the original four data blocks (A, B, C, D) cannot be overwritten until the complete segment of memory (e.g. flash memory) is erased. Thus, in order to write to the segment with invalid data (A, B, C, D) all good data four new data blocks (E, F,G, H) and four replacement data blocks (A′, B′, C′, D′) are read and written to a new segment then the old segment is erased. In some embodiments, the encoding engine 310 may use an algorithm such as, but not limited to, a garbage collection algorithm to perform the above-steps of method 1100. Garbage collection algorithms may include Reference Counting algorithms, Mark-Sweep Collector algorithm, Mark-Compact Collector algorithm, Copying Collector algorithm, etc. The operations in step 1108 may be performed by the encoding engine 310 in cooperation with the data-tracking module 212 and one or more other entities of the computing device 200.

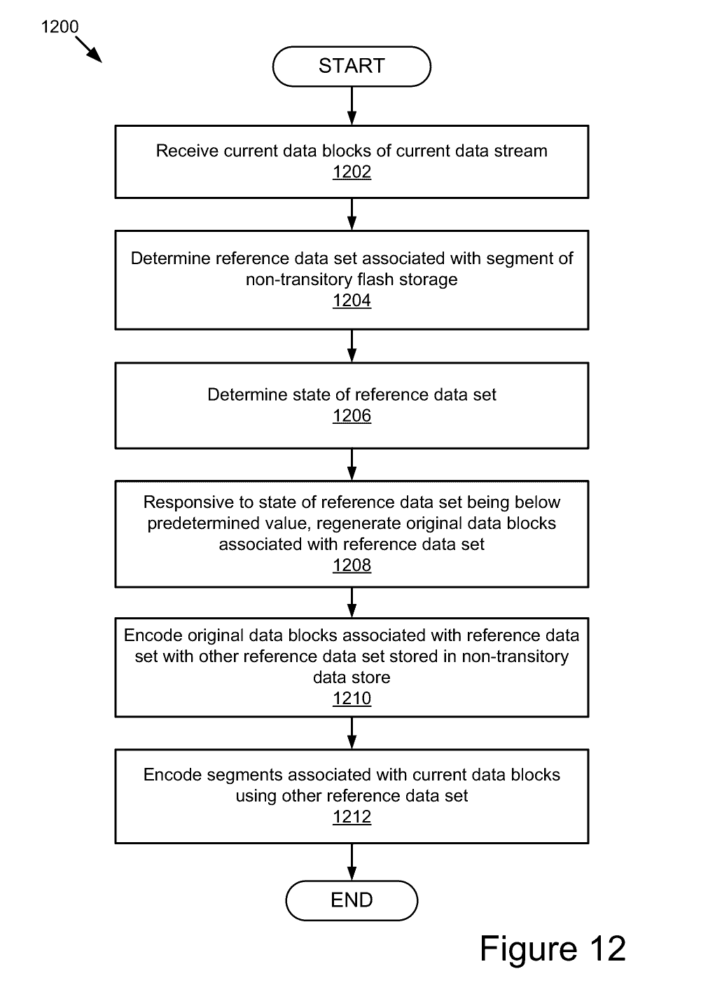

FIG. 12 is a flow chart of an example method 1200 for encoding data segments associated with flash management and garbage collection integration. The method 1200 may begin by receiving 1202 current data blocks of current data stream. In some embodiments, the operations in step 1202 may be performed by the signature fingerprint computation engine 306 in cooperation with the matching engine 308 and one or more other entities of the computing device 200.

Next, the method 1200 advances by determining 1204 a reference data set associated with the segments of flash storage based on the current data blocks. In one embodiment, the data-tracking module 212 determines a reference data set associated with a segment of non-transitory flash data store based on an identifier (e.g. segment header) of the reference data set. In one embodiment, the data-tracking module 212 identifies segments of memory of a non-transitory flash data store including reference data sets. For instance, an identified segment in memory of the non-transitory data store may reflect a degree of similarity between the current data blocks and a reference data set associated with the identified segment.

Responsive to determining a reference data set, the method 1200 can continue by determining 1206 a state of the reference data set. In some embodiments, the data-tracking module 212 may determine a state of the reference data set. For instance, the data tracking module 212 may compare and redistribute one or more data blocks from partially filled segments based on the state of the reference data set, and delete invalid data blocks (i.e. stale data, data due for deletion) that are part of the reference data set such that a segment and/or data block of a reference data set can be reassigned.

The method 1200 may continue by regenerating 1208 original data blocks associated with a reference data set. In one embodiment, the encoding engine 310 regenerates original data blocks associated with the reference data set responsive to the state of the reference data set being below a predetermined value. The state of the reference set being below a predetermined value can be indicative that the reference date set is scheduled for retirement. Next, the method 1200 advances by encoding 1210 the original data blocks associated with the reference data set scheduled for retirement with other reference data sets stored in memory of the non-transitory data store. The other reference data sets may include available storage for storing additional data blocks, such as the original data blocks of the reference data set scheduled for retirement. In one embodiment, the data-clustering module 214 identifies one or more available segments in memory of a non-transitory data store for storing the encoded original data blocks. The operations in step 1210 may be performed by the encoding engine 310 in cooperation with the data-tracking module 212 and one or more other entities of the computing device 200.

Next, the method 1200 may continue by encoding 1212 segments associated with current data blocks of a current data stream using the other reference data sets. In one embodiment, the encoding engine 310 identifies one or more other segments including other reference data sets stored in memory of a non-transitory data store (e.g. flash memory). In some embodiments, the current data blocks can be segmented into chunks (i.e. segments) and the encoding engine 310 can encode the chunks independently with one or more other reference data sets of segments in memory of non-transitory data store. The operations in step 1212 can be performed by the encoding engine 310 in cooperation with one or more other entities of the computing device 200.

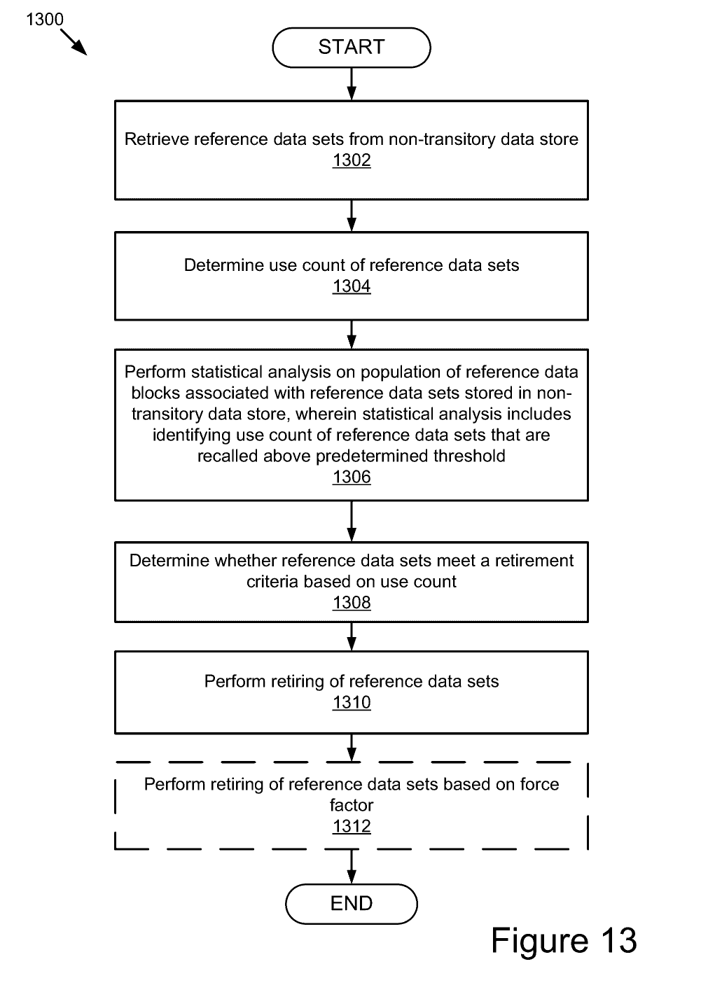

FIG. 13 is a flow chart of an example method 1300 for retiring a reference data set associated with flash management. The method 1300 may begin by retrieving 1302 reference data sets from memory of data store such as, data storage repository 110/220. In one embodiment, the data retirement module 216 in cooperation with one or more other components of computing device 200 retrieves one or more reference data sets stored in memory of non-transitory data store (e.g. flash memory). Next, the method 1300 may continue by determining 1304 a use count variable of the reference data sets. In one embodiment, the data retirement module 216 in cooperation with the data-tracking module 212 determine use count variables associated with one or more reference data sets. The data retirement module 216 may parse a records table stored in a data store and identify a use count variable of a reference data set based on an identifier associated with the reference data set. A use count variable may be indicative of a number of data blocks and/or set of data blocks that reference (e.g. point to the reference data set in storage using a pointer) a particular reference data set in memory of a non-transitory data store (e.g. flash memory).

The method 1300 may then continue by performing 1306 a statistical analysis on population of reference data blocks associated with reference data sets stored in memory of non-transitory data store. For instance, the data-tracking module 212 may perform a statistical analysis on population of reference data blocks associated with reference data sets stored in memory of non-transitory data store (e.g. flash memory). The statistical analysis may include, but is not limited to, identifying use count of reference data sets that are data recalled above a predetermined threshold. In some embodiments, the data retirement module 216 determines whether a reference data set satisfies for retirement based on use count variable associated with the reference data set. The operations in step 1306 may be performed by the data-tracking module 212 in cooperation with one or more other entities of the computing device 200.

Next, the method 1300 may advance by determining 1308 whether the reference data sets meet a retirement criteria based on the use count. A retirement criteria may include, but is not limited to, a duration of use associated with a data set, last update/modification performed on an associated data set, amount of memory used for an associated data set over a duration, amount of time and resources necessary for accessing data set stored in memory during normal execution, frequency of read/write associated with data set, etc. In one embodiment, the reference hash table module 314 may determine that one or more data blocks and/or sets of data blocks have not referenced a reference data set for a predetermined duration (e.g. minutes, hours, days, weeks, etc.). In some embodiments, the reference hash table module 314 may determine that a reference data set is above a threshold frequency of read/write associated with data set and thus retirement may be satisfied to preserve a life span of the storage device (i.e. flash storage). In further embodiments, the reference hash table module 314 may determine that a reference data set meets retirement based on the amount of memory used in a storage device (i.e. flash storage) over a duration for an associated data set. For instance, a data set may grow in memory over a duration based on revisions performed to the data set (e.g. updating a document over time to include additional information). In some embodiments, the data set may be forced to retire if the amount of memory used in the storage device meets a threshold and has not been recalled for duration of time, thus, clearing stale data and providing memory space for relevant data. The method 1300 may continue by performing retiring 1310 of the reference data sets. In one embodiment, the data retirement module 216 perform retiring of one or more reference data sets that meet the criteria based on the use count.

In some embodiments, the reference hash table module 314 applies a use-count-retirement algorithm to each reference data set stored in storage. The use-count-retirement algorithm may automatically decrement a count of a use count variable associated with a reference data set after a predetermined duration is satisfied and the reference data set has not been referenced by one or more data blocks or sets of data blocks associated with a data stream during the predetermined duration. In some embodiments, a reference data set may satisfy for retirement when a count of the use count variable of the reference data set decrements to zero. A use count variable of zero may indicate that no data blocks or sets of data blocks rely and/or reference to that corresponding reference data set. For example, no encoded data blocks (e.g. compressed/deduped data blocks) rely on a reference data set for reconstructing an original version of the encoded data block. In further embodiments, a portion of the reference data set is determined for retirement based on the statistical analysis. The data retirement module 216 may then retire the portion of reference data blocks of the reference data set that satisfy for retirement while concurrently assigning the remainder of reference data blocks in the reference data set to a new segment (e.g. new reference data set with available space for additional data blocks) of memory in storage based on one or more predetermined factors (e.g. storage space, size of reference data blocks, retirement timestamp of the reference data blocks, etc.).

The method 1300 may continue by performing 1312 retiring of the reference data sets based on a force factor. In one embodiment, the data retirement module 216 performs retiring of one or more reference data sets stored in memory of a non-transitory data store (e.g. 110/220) based on a force factor. The force factor may be embedded within an algorithm such as, but not limited to, a garbage collection algorithm. The operations in step 1312 may be optional and performed by the data retirement module 216 in cooperation with one or more other entities of the computing device 200.

FIG. 14A is a block diagram illustrating a prior art example for compressing a reference data block. As depicted in FIG. 14A a compression module receives a reference block for inline compression of data associated with the reference block. Inline compression means that data of the reference block is compressed (e.g. reduced in size) as it is stored in a storage array. The reference block prior to entering the compression module has a data size of 4 KB (kilobytes), once the reference block emerges from the compression module the size of the reference block is significantly reduced. The compressed data stream is then stored in storage. Furthermore, the compressed data stream may include a header (e.g. Hdr) that includes identification information, etc. The disadvantage of performing inline compression is that the compression module consolidates data of the reference block prior to being written to memory. In addition, hashing and hash comparison are computed in real-time, this can add performance overhead. For instance, if a byte-for-byte comparison is required for avoiding hash collisions, additional performance overhead is introduced. In cases of compressing primary data of reference blocks when time (i.e. milliseconds) are significant, inline compression is generally not recommended. Thus, inline compression for data streams is not recommended due to the total overhead performance introduced to the system.

FIG. 14B is a block diagram illustrating a prior art example for deduping a reference data block. As depicted in FIG. 14B a de-dupe (deduplication) module receives a reference block for inline deduplication of data associated with the reference block. Inline deduplication is a technique for reducing storage needs by eliminating redundant data. For instance as depicted in FIG. 14B, the reference block prior to entering the de-dupe module has a data size of 4 KB (kilobytes), once the reference block emerges from the de-dupe module the size of the reference block is significantly reduced. The deduplicated data stream including a header (e.g. Hdr) that includes identification information, are then stored in storage.

Furthermore, in-line deduplication includes the deduplication hash calculations being generated on client devices as the reference data blocks enter the client device in real time. If the client device spots a block that it already stored on the storage system it does not store the new block, but rather, simply makes a reference to the existing reference block. The benefit of in-line deduplication is that it requires less storage as data is not duplicated. However, because the hash calculations and lookup operations in a hash table experience significant time delays resulting in data ingestion being significantly slower, efficiency is decreased as the backup throughput of the device is reduced.

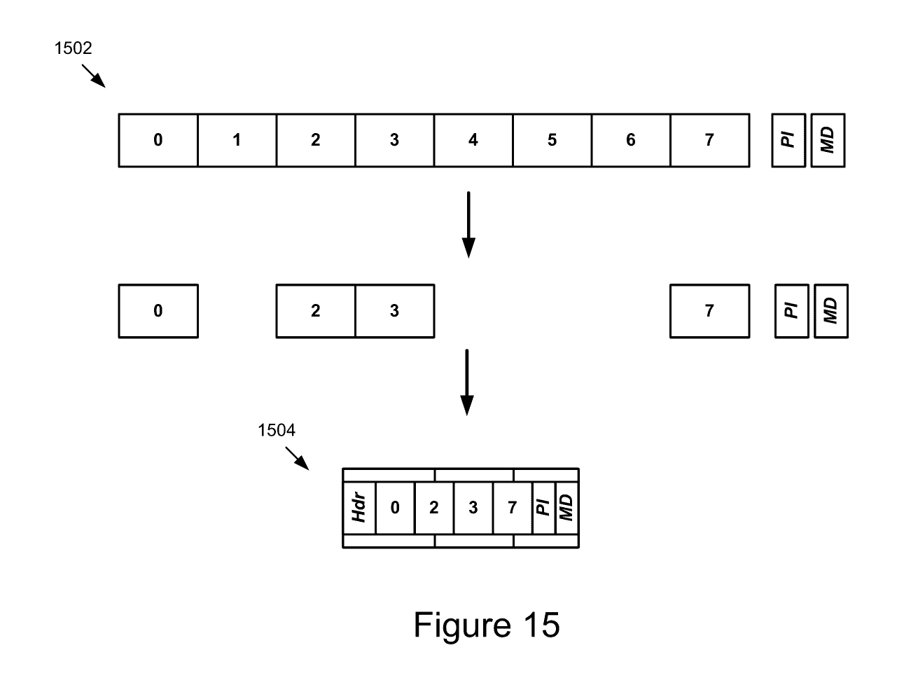

FIG. 15 is a graphical representation illustrating an example delta encoding. As depicted in FIG. 15, a data set 1502 may include data blocks (0-7) as illustrated. For instance, the data set 1502 can be associated with an incoming data stream prompted for being stored in a data store such as, data storage repository 110/220. Prior to storing the data set 1502 including the data blocks (0-7), the encoding engine 310 may perform sub-block level deduplication that includes comparing resemblance hashes of the data blocks (0-7) to stored resemblance hashes of corresponding reference data sets (not shown) stored in a data store. If similar-based resemblance hashes exist between data blocks of the data set 1502 and one or more existing reference data sets (not shown) stored in the data store, the encoding engine 310 may then encode the corresponding data blocks associated with the similar-based resemblance hashes, as depicted in FIG. 15 by data blocks (0, 2, 3, and 7), using the existing reference data set in storage.

The encoding engine 310 can be performed by a delta-encoding algorithm. Delta encoding algorithms identify similar resemblance hashes between data blocks and a reference data set and stores only the changed data. For instance, the encoded data blocks (0, 2, 3, and 7) are illustrated as an encoded (e.g. compressed) data stream 1504 version of the original data set. Furthermore, the encoded data stream 1504 may include a header for identifying the encoded data stream. The header may also, include information such as, but not limited to, a reference block ID, delta encoding bit-vector, and number of grains associated with the encoded data stream.

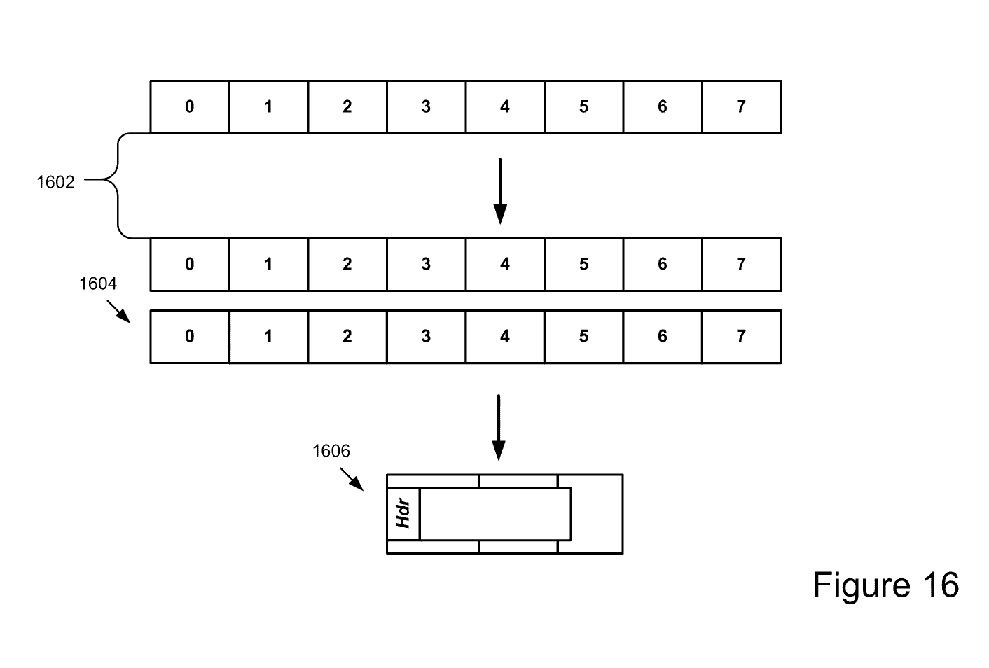

FIG. 16 is a graphical representation illustrating an example resemblance encoding. As depicted in FIG. 16, a data set 1602 may include data blocks (0-7) as illustrated. For instance, the data set 1602 can be associated with an incoming data stream prompted for being stored in a data store such as, data storage repository 110. The encoding engine 310 may perform block level deduplication that includes comparing resemblance hashes and/or digital signatures/fingerprints of the data blocks (0-7) to stored resemblance hashes of corresponding reference data set 1604 as illustrated in FIG. 16. If similar-based resemblance hashes exist between data blocks of the data set 1602 and the reference data set 1604, the encoding engine 310 may then encode the corresponding data blocks associated with the similar-based resemblance hashes, as depicted in FIG. 16. The encoding engine 310 may perform deduplication and self-compression on the corresponding data blocks associated with the similar-based resemblance hashes. The encoded data blocks 1606 are illustrated as an encoded (e.g. compressed) data stream version of the original data set 1602. Further, the encoded data stream 1606 may also, include the header for identifying the encoded data stream. The header may also, include information such as, but not limited to, a reference block ID, all zeroes bit-vector, and number of grains associated with the encoded data stream.

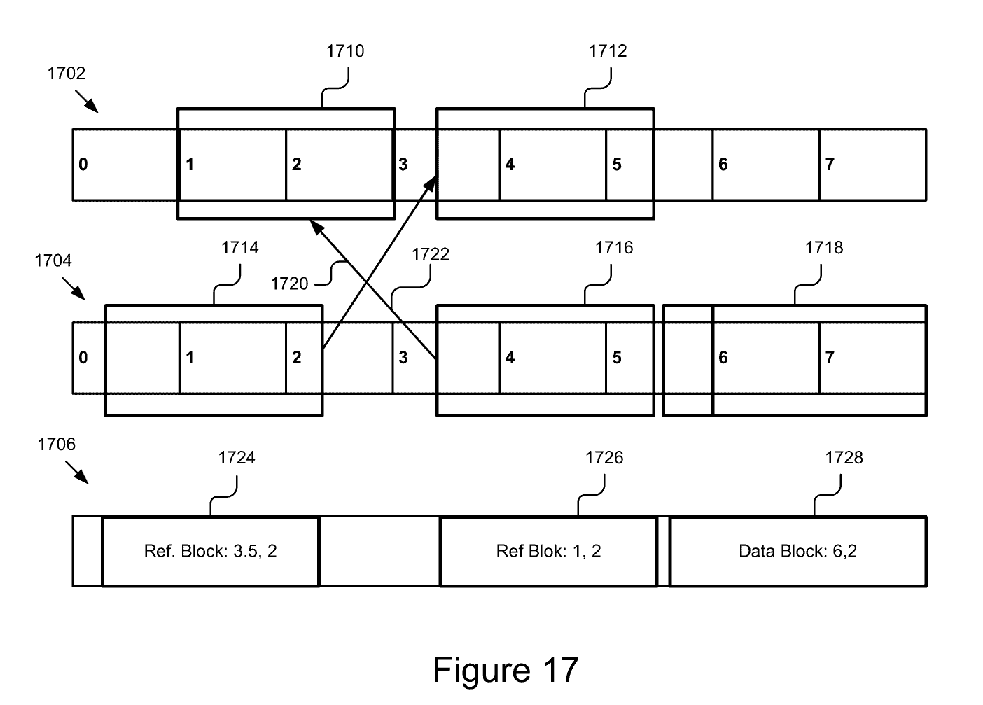

FIG. 17 is a graphical representation illustrating example delta and self-compression of a reference data block. As depicted in FIG. 17, a reference data set 1702 that includes reference data blocks (0-7) and a data set 1704 including data blocks (0-7) are illustrated. The purpose of FIG. 17 is to illustrate encoding the data set using delta and self-compression algorithm. For instance, an encoding engine 310 can process the data blocks of the data set 1704 by calculating resemblance hashes 1710, 1712, 1714, 1716 and 1718. If the resemblance hashes, do not have a similar match between the reference data blocks of the reference data set 1702 and the data blocks of the data set 1704, delta compression can be performed. Also, a sketch can be computed of the data set. The sketch can be computed based on the resemblance hashes across each data block of the data set 1704. If no similarity match for the data blocks of the data set 1704 exists, the sketch can be stored in a data store without being encoded. If a similar match exits between resemblance hashes (e.g. sketches) of the data blocks of the data set 1704 and resemblance hashes (e.g. sketches) of the reference data set 1702 then the corresponding data blocks of the data set 1704 that are associated with the similar match are encoded as shown via 1720 and 1722, and this results in data storage efficiency benefits.

In context of FIG. 17, data blocks of the data set 1704 are associated with a similar match but have a few differences (e.g. content modifications) compared to the reference data blocks of the reference data set 1702, as shown in bolded squares. The encoding engine 310 may then compute a difference relative to the reference data blocks, and store the modified data blocks 1724, 1726 and 1728 as well as a hash value to the reference data set and/or reference data block exclusively. Further, the encoded data set 1706 may include the header for identifying the encoded data stream. The header may also, include information such as, but not limited to, a reference block ID as shown in FIG. 17 (e.g. ref blk: 3.5, 2), all zeroes bit-vector, and number of grains associated with the encoded data stream.

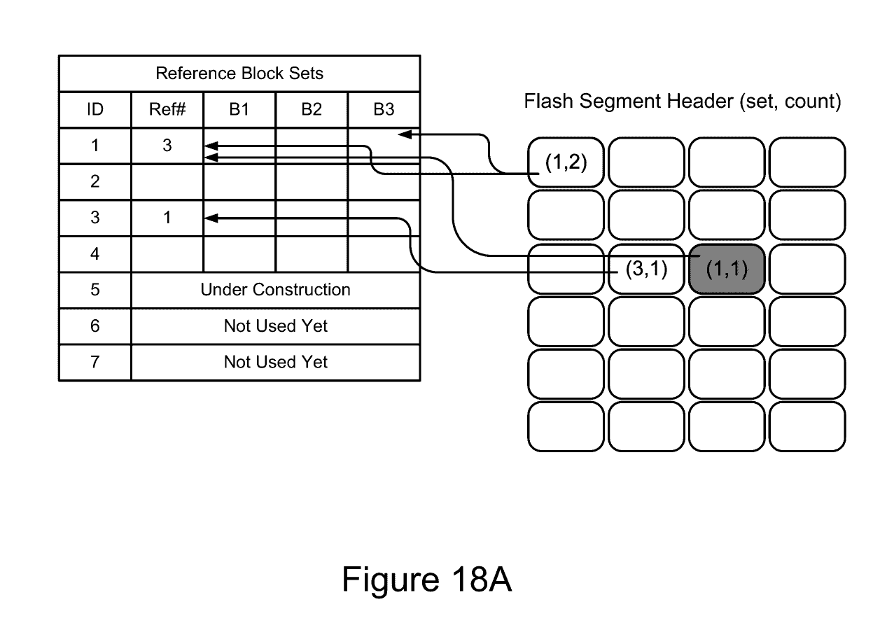

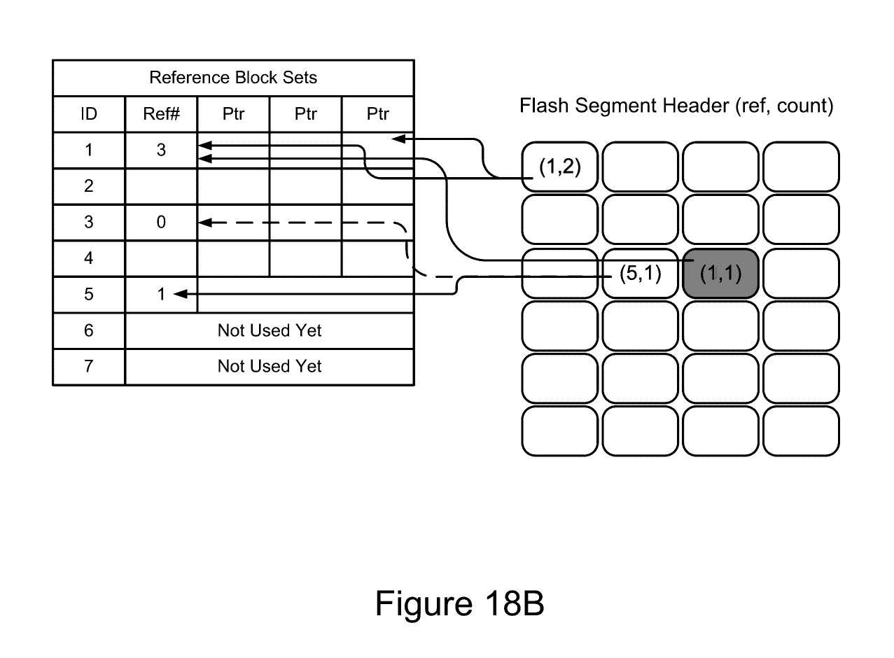

FIGS. 18A and 18B are graphical representations illustrating exemplary tracking and retirement of reference block sets using garbage collection in flash management. Referring now to FIG. 18A, a reference block sets table and a plurality of segments of memory in flash storage devices with a corresponding flash segment header is illustrated. As depicted a portion of the segments of memory associated with the flash storage device are occupied. For instance, the portions of the segments occupied are related to the portions including (1, 2), (3, 1) and (1, 1). These portions of segments associated with the flash storage device include a corresponding flash segment header that identifies a reference set that the segment points to, in association to the reference block sets and an associated count. For example, in the illustrated embodiment, the portion of occupied segments in the flash storage device indicated by (3, 1) reflects that the segment uses a reference data set 3 and the reference data set 3 has one set pointing to it as depicted in the reference block sets table. The reference block sets table also includes information indicating that portions of memory in the storage device are either in use, under construction and/or not use yet.

Referring now to FIG. 18B, illustrating tracking and retiring of reference block sets using garbage collection in flash management. For instance, as previously discussed in FIG. 18A a portion of the segments of memory associated with the flash storage device were occupied. For instance, the portions of the segments occupied are related to the portions including (1, 2), (3, 1) and (1, 1). However, in FIG. 18B the segment header of block (3, 1) now reads (5, 1) indicating that block (5, 1) points to a new reference data set in memory of the flash storage device. Furthermore, the reference block sets table has been modified which now shows that ref# 1 associated with ID-3 has been modified to ref#0 indicating that no data blocks stored in flash storage segments points to that corresponding reference data set. Furthermore, the reference data set associated with ID-5 now has ref # of 1 indicating that one segment of flash memory points to the reference data set.

Systems and methods for implementing an efficient data management architecture are described below. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware. Moreover, the technologies disclosed above primarily in the context of on line services; however, the disclosed technologies apply to other data sources and other data types (e.g., collections of other resources for example images, audio, web pages).

Reference in the specification to “one implementation” or “an implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware implementation, an entirely software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A method comprising:
receiving data blocks of an incoming data stream;
determining a first reference data set associated with a segment of data store based on the received data blocks;
determining a state of the first reference data set;
determining whether the first reference data set meets a retirement criteria based on the state; and
responsive to meeting the retirement criteria, performing retiring of the first reference data set.

2. The method of claim 1, further comprising:
responsive to the state of the first reference data set being below a predetermined value, regenerating original data blocks of the first reference data set; and
encoding the original data blocks of the first reference data set and the received data blocks of the incoming data stream with a second reference data set stored in the data store.

3. The method of claim 1, further comprising:
responsive to the state of the first reference data set being above the predetermined value, encoding the received data blocks using the first reference data set; and
assigning the segment associated with the first reference data set to a new location in the data store for storage.

4. The method of claim 1, further comprising:
updating a use count associated with the first reference data set;
determining whether the reference data set meets a retirement criteria based on the use count; and
responsive to meeting the retirement criteria, performing retiring of the first reference data set.

5. The method of claim 1, further comprising retiring the first reference data set based on a force factor.

6. The method of claim 5, wherein the force factor is client defined.

7. The method of claim 1, further comprising:
performing a statistical analysis on a population of data blocks associated with the first reference data set stored in the data store, wherein the statistical analysis includes identifying other reference data sets that are recalled above a predetermined threshold.

8. A system comprising:
a processor; and
a memory storing instructions that, when executed, cause the system to:
receive data blocks of an incoming data stream;
determine a first reference data set associated with a segment of data store based on the received data blocks;
determine a state of the first reference data set;
determine whether the first reference data set meets a retirement criteria based on the state; and
responsive to meeting the retirement criteria, perform retiring of the first reference data set.

9. The system of claim 8, further comprising:
responsive to the state of the first reference data set being below a predetermined value, regenerating original data blocks of the first reference data set; and
encoding the original data blocks of the first reference data set and the received data blocks of the incoming data stream with a second reference data set stored in the data store.

10. The system of claim 8, further comprising:
responsive to the state of the first reference data set being above the predetermined value, encoding the received data blocks using the first reference data set; and
assigning the segment associated with the first reference data set to a new location in the data store for storage.

11. The system of claim 8, further comprising:
updating a use count associated with the first reference data set;
determining whether the reference data set meets a retirement criteria based on the use count; and
responsive to meeting the retirement criteria, performing retiring of the first reference data set.

12. The system of claim 8, further comprising retiring the first reference data set based on a force factor.

13. The system of claim 12, wherein the force factor is client defined.

14. The system of claim 8, further comprising:
performing a statistical analysis on a population of data blocks associated with the first reference data set stored in the data store, wherein the statistical analysis includes identifying other reference data sets that are recalled above a predetermined threshold.

15. A computer program product comprising a non-transitory computer usable medium including a computer readable program, wherein the computer readable program when executed on a computer causes the computer to:
receive data blocks of an incoming data stream;
determine a first reference data set associated with a segment of data store based on the received data blocks;
determine a state of the first reference data set;
determine whether the first reference data set meets a retirement criteria based on the state; and
responsive to meeting the retirement criteria, perform retiring of the first reference data set.

16. The computer program product of claim 75, further comprising:
responsive to the state of the first reference data set being below a predetermined value, regenerating original data blocks of the first reference data set; and
encoding the original data blocks of the first reference data set and the received data blocks of the incoming data stream with a second reference data set stored in the data store.

17. The computer program product of claim 15, further comprising:
responsive to the state of the first reference data set being above the predetermined value, encoding the received data blocks using the first reference data set; and
assigning the segment associated with the first reference data set to a new location in the data store for storage.

18. The computer program product of claim 15, further comprising:
updating a use count associated with the first reference data set;
determining whether the reference data set meets a retirement criteria based on the use count; and
responsive to meeting the retirement criteria, performing retiring of the first reference data set.

19. The computer program product of claim 15, further comprising retiring the first reference data set based on a force factor.

20. The computer program product of claim 19, wherein the force factor is client defined.

21. The computer program product of claim 15, further comprising:
performing a statistical analysis on a population of data blocks associated with the first reference data set stored in the data store, wherein the statistical analysis includes identifying other reference data sets that are recalled above a predetermined threshold.
